(19) United States
(12) Patent Application Publication
(10) Pub. No.: US 2023/0260200 A1
(43) Pub. Date: Aug. 17, 2023

(54) Explicit Radiance Field Reconstruction from Scratch

(71) Applicant: Meta Platforms, Inc., Menlo Park, CA (US)

(72) Inventors: Samir Aroudj, London (GB); Michael Goesele, Woodinville, WA (US); Richard Andrew Newcombe, Seattle, WA (US); Tanner Schmidt, Seattle, WA (US); Florian Eddy Robert Ilg, Kirkland, WA (US); Steven John Lovegrove, Woodinville, WA (US)

(21) Appl. No.: 18/160,937

(22) Filed: Jan. 27, 2023

Related U.S. Application Data
(60) Provisional application No. 63/305,075, filed on Jan. 31, 2022.

(51) Int. Cl. G06T 15/20; G06T 15/06; G06T 17/00; G06T 7/70; G06T 3/40

(52) U.S. Cl. CPC G06T 15/20; G06T 3/4007; G06T 7/70; G06T 15/06; G06T 17/005

(57) ABSTRACT

In one embodiment, a method includes determining a viewing direction of a scene and rendering an image of the scene for the viewing direction, wherein the rendering comprises: for each pixel of the image, casting a view ray into the scene, and for a particular sampling point along the view ray, determining a pixel radiance associated with surface light field (SLF) and opacity, which comprises identifying multiple voxels within a threshold distance to the particular sampling point, wherein each of the voxels is associated with a respective local plane, for each the voxels computing a pixel radiance associated with SLF and opacity based on locations of the particular sampling point and the local plane associated with that voxel, and determining the pixel radiance associated with SLF and opacity for the particular sampling point based on interpolating the pixel radiances associated with SLF and opacity associated with the multiple voxels.

### PRIORITY

This application claims the benefit under 35 U.S.C. § 119(e) of U.S. Provisional Patent Application No. 63/305075, filed 31 Jan. 2022, which is incorporated herein by reference.

### TECHNICAL FIELD

This disclosure generally relates to 3D reconstruction, and in particular relates to optimization for 3D reconstruction.

### BACKGROUND

In computer vision and computer graphics, 3D reconstruction is the process of capturing the shape and appearance of real objects. This process can be accomplished either by active or passive methods. The research of 3D reconstruction has always been a difficult goal. By using 3D reconstruction one can determine any object’s 3D profile, as well as knowing the 3D coordinate of any point on the profile. The 3D reconstruction of objects is a generally scientific problem and core technology of a wide variety of fields, such as computer aided geometric design (CAGD), computer graphics, computer animation, computer vision, medical imaging, computational science, virtual reality, digital media, etc.

### SUMMARY OF PARTICULAR EMBODIMENTS

In particular embodiments, 3D reconstruction may comprise the process that creates a 3D model. A computing system may use explicit dense 3D reconstruction by processing a set of multi-view images of a scene with sensor poses and calibrations and estimating a photo-real digital model. Existing techniques for 3D reconstruction may include approaches based on implicit representation (such as NeRF), which may not allow users to examine what is learned. By contrast, explicit representations may have meanings and may be tweaked as needed. Therefore, the embodiments disclosed herein may learn a 3D scene model comprising a volumetric representation that may be completely explicit. Specifically, a sparse voxel octree may be used as the data structure for organizing voxel information. Each leaf of the sparse voxel octree may store opacity, radiance, etc. Each internal node of the sparse voxel octree may represent a larger volume. The nodes of the sparse voxel octree may be optimized during 3D reconstruction. Although this disclosure describes particular reconstructions in a particular manner, this disclosure contemplates any suitable reconstruction in any suitable manner.

In particular embodiments, the computing system may determine a viewing direction associated with a scene. The computing system may further render an image associated with the scene for the viewing direction. In particular embodiments, the rendering may comprise the following steps. The computing system may, for each pixel of the image, cast a view ray into the scene. For a particular sampling point along the view ray, the computing system may then determine a pixel radiance associated with surface light field (SLF) and opacity. In particular embodiments, determining the pixel radiance associated with surface light field (SLF) and opacity may comprise the following steps. The computing system may identify a plurality of voxels within a threshold distance to the particular sampling point. Each of the voxels may be associated with a respective local plane. For each the voxels, the computing system may then compute a pixel radiance associated with SLF and opacity based on locations of the particular sampling point and the local plane associated with that voxel. The computing system may further determine an updated pixel radiance associated with SLF and opacity for the particular sampling point based on interpolating the plurality of pixel radiances associated with SLF and opacity associated with the plurality of voxels.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates an example from-scratch reconstruction of a plush lion.

FIG. 2 illustrates an example sketch of the scene model.

FIG. 3 illustrates an example 1D field with 4 plane-based samples and the example result of blending them together.

FIG. 4 illustrates an example reconstruction with and without local plane-based interpolation of SVO fields.

FIG. 5 illustrates an example volume rendering comparison using the bulldozer scene.

FIG. 6 illustrates example intermediate ficus scene models after optimizing the SVO fields showing the initial dense SVO (left) and the SVO sparsified after 30k mini batch iterations (right).

FIG. 7 illustrates an example pixel sampling comparison using the NeRF room scene for a test view after 175k iterations.

FIG. 8 illustrates example reconstructions for exemplary synthetic scenes from NeRF.

FIG. 9 illustrates an example qualitative evaluation using JaxNeRF and ours on the leaves and orchid scene.

FIG. 10 illustrates an example reconstruction of the object of interest inside the scene AABB by our method.

FIG. 11 illustrates example differences in reconstruction quality for varying numbers of SH bands to represent outgoing surface radiance.

FIG. 12 illustrates an example comparison of reconstruction results for varying prior strengths.

FIG. 13 illustrates an example scene sampling influence on results after 2.5 k iterations of the Lion scene with varying sampling budgets.

FIG. 14 illustrates example scene sampling influence on results of the Lion scene after 40k iterations and with varying sampling budgets.

FIG. 15 illustrates an example qualitative evaluation using an overview of our results for all of the synthetic NeRF scenes.

FIG. 16 illustrates an example robustness experiment on a synthetic scene.

FIG. 17 illustrates an example method for explicit 3D reconstruction.

FIG. 18 illustrates an example computer system.

### DESCRIPTION OF EXAMPLE EMBODIMENTS

In particular embodiments, 3D reconstruction may comprise the process that creates a 3D model. A computing system may use explicit dense 3D reconstruction by processing a set of multi-view images of a scene with sensor poses and calibrations and estimating a photo-real digital model. Existing techniques for 3D reconstruction may include approaches based on implicit representation (such as NeRF), which may not allow users to examine what is learned. By contrast, explicit representations may have meanings and may be tweaked as needed. Therefore, the embodiments disclosed herein may learn a 3D scene model comprising a volumetric representation that may be completely explicit. Specifically, a sparse voxel octree may be used as the data structure for organizing voxel information. Each leaf of the sparse voxel octree may store opacity, radiance, etc. Each internal node of the sparse voxel octree may represent a larger volume. The nodes of the sparse voxel octree may be optimized during 3D reconstruction. Although this disclosure describes particular reconstructions in a particular manner, this disclosure contemplates any suitable reconstruction in any suitable manner.

In particular embodiments, the computing system may determine a viewing direction associated with a scene. The computing system may further render an image associated with the scene for the viewing direction. In particular embodiments, the rendering may comprise the following steps. The computing system may, for each pixel of the image, cast a view ray into the scene. For a particular sampling point along the view ray, the computing system may then determine a pixel radiance associated with surface light field (SLF) and opacity. In particular embodiments, determining the pixel radiance associated with surface light field (SLF) and opacity may comprise the following steps. The computing system may identify a plurality of voxels within a threshold distance to the particular sampling point. Each of the voxels may be associated with a respective local plane. For each the voxels, the computing system may then compute a pixel radiance associated with SLF and opacity based on locations of the particular sampling point and the local plane associated with that voxel. The computing system may further determine an updated pixel radiance associated with SLF and opacity for the particular sampling point based on interpolating the plurality of pixel radiances associated with SLF and opacity associated with the plurality of voxels.

The embodiments disclosed herein present a novel explicit dense 3D reconstruction approach that processes a set of images of a scene with sensor poses and calibrations and estimates a photo-real digital model. One of the key innovations may be that the underlying volumetric representation is completely explicit in contrast to neural network-based (implicit) alternatives. The embodiments disclosed herein may encode scenes explicitly using clear and understandable mappings of optimization variables to scene geometry and their outgoing surface radiance. The embodiments disclosed herein may represent them using hierarchical volumetric fields stored in a sparse voxel octree. Robustly reconstructing such a volumetric scene model with millions of unknown variables from registered scene images only may be a highly non-convex and complex optimization problem. To this end, the embodiments disclosed herein may employ stochastic gradient descent (Adam) which is steered by an inverse differentiable renderer.

The embodiments disclosed herein demonstrate that our method may reconstruct models of high quality that are comparable to state-of-the-art implicit methods. Importantly, the embodiments disclosed herein may not use a sequential reconstruction pipeline where individual steps suffer from incomplete or unreliable information from previous stages, but may start our optimizations from uniformed initial solutions with scene geometry and radiance that is far off from the ground truth. The embodiments disclosed herein show that our method may be general and practical. It may not require a highly controlled lab setup for capturing, but may allow for reconstructing scenes with a vast variety of objects, including challenging ones, such as outdoor plants or furry toys. Finally, our reconstructed scene models may be versatile thanks to their explicit design. They may be edited interactively which is computationally too costly for implicit alternatives.

The vast field of 3D reconstruction has been researched actively. Yet, there has recently been a strong increase in interest in the field due to the availability of powerful optimization techniques such as Adam combined with novel neural-network-based extensions of such traditional conventional works. The embodiments disclosed herein may also employ powerful optimization techniques, but in contrast to the current research trend, which creates the impression that state-of-the-art reconstructions are only possible using neural-network-based models, the embodiments disclosed herein may reconstruct explicit high-quality 3D models from scratch, i.e., only from multi-view images (with sensor poses and calibrations). In the course of this, the embodiments disclosed herein may employ inverse differentiable rendering paired with Adam as a variant of stochastic gradient descent (SGD) and without any implicit components based on neural networks. That way, the embodiments disclosed herein may provide a practical reconstruction method for editable models. Specifically, it may allow for capturing of static scenes by simply taking photos from different viewpoints.

In contrast, the recently conventional works NeRF and IDR as well as their many follow-up works employ implicit scene representations (often multi-layer perceptrons (MLPs)). These network-based methods may be able to generate novel views with extremely high fidelity, while only requiring very compact implicit scene models. However, the fact that the internals of these implicit models may not be interpreted poses significant challenges and leveraging the success of traditional graphics and vision techniques by combining them with implicit models may be an open and challenging research question. Scaling purely implicit models for large-scale scenes may be also challenging. It may be unclear how to properly increase the capacity of purely implicit models, i.e., how to extend the black box internals, in a controlled manner without overfitting or over-smoothing artifacts. Avoiding these limitations motivated recent hybrid extensions as mixes of implicit and explicit models. Additionally, implicit models may come at the cost of reduced versatility. In particular, they may be less suited for 3D content authoring, e.g., using interactive tools such as Blender. Editing operations on implicitly defined model parts first may have to go through a black box compression layer inherent to their implicit definition which entails costly optimization. Although, some conventional works focus on editing of implicit models, they may be rather a proof of concept targeting small-scale synthetic objects and may be too costly for practical use.

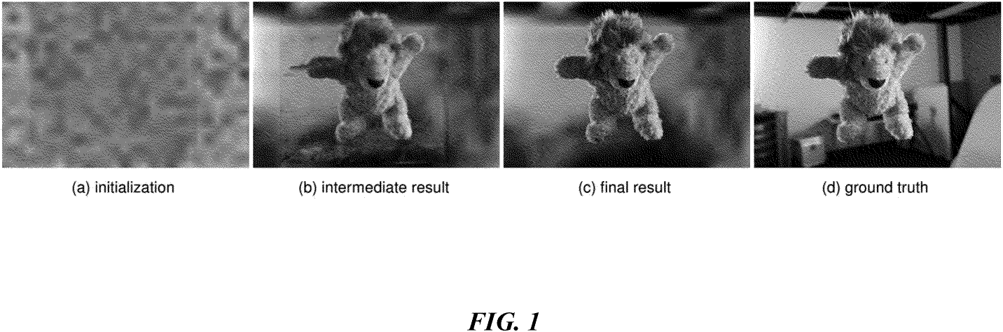

The embodiments disclosed herein may address these aforementioned shortcomings. The embodiments disclosed herein may design an explicit approach with the benefits of being interpretable, scalable and editable. FIG. 1 illustrates an example from-scratch reconstruction of a plush lion. The reconstruction is demonstrated by three renderings (left) which gradually match a hold-out test photo (right). Our method may handle complex scenes with tiny intricate scene details, e.g., the fur of the plush lion in FIG. 1. The embodiments disclosed herein further demonstrate that our reconstructed models may be suitable for post processing, such as interactive editing via tools like Blender, and that they may be comparable to state-of-the-art implicit models regarding photo consistency.

The embodiments disclosed herein may have the following contributions. One contribution may include a hierarchical, multi-resolution, sparse grid data structure using sparse voxel octrees (SVOs) with 3D fields for opacity and outgoing radiance surface light fields (SLFs) to explicitly represent scene geometry and appearance. Another contribution may include a storage and interpolation scheme using local planes to efficiently represent 3D fields with little voxel artifacts. Another contribution may include a simple, yet effective background model for distant scene radiance to handle unbounded scene volumes. Another contribution may include an opacity compositing rendering algorithm that takes pixel footprints into account and thus avoids level of detail (LoD) aliasing. Another contribution may include a uniform, hierarchical (coarse-to-fine) optimization scheme to make the approach feasible and scalable. Another contribution may include a practical reconstruction method for freely captured multi-view images of static scenes, neither requiring object masks, nor a sophisticated model initialization.

Our novel scene representation may have several benefits. The embodiments disclosed herein may represent scenes using complex (high-dimensional), continuous, volumetric and differentiable 3D fields suitable for intricate geometry details that leverage powerful optimization methods such as Adam. Unlike ours, previous explicit and discrete representations, such as multi-sphere images (MSIs) or general meshes, may make strong assumptions or may be inherently difficult to optimize due to their challenging objective function originating from their discrete model design. Compared to network-based alternatives, while using more memory, our scene representation may be explicit and better suited for interactive editing as transformation operations do not go through an additional compression layer inherent to implicit model definitions. Further, our explicit models may facilitate research to leverage the strengths of traditional graphics techniques. As an example and not by way of limitation, our spatial scene partitioning may directly accelerate ray-based queries of scenes, which may be fundamental to implement complex shading, instead of directly storing SLFs. The embodiments disclosed herein demonstrate a versatile and practical explicit approach that may neither require a restrictive laboratory setup, nor need object masks which tend to be difficult to acquire or might be inaccurate (hard or impossible for intricate geometry like the fur in FIG. 1). Finally, our 4D scene partitioning (3D space plus LoD) may be uniform and straightforward to apply to captured scenes. It may neither require an artificial LoD separation, nor require a special scene-dependent parameterization.

In the following, this disclosure provides a short overview of closely related works, whereas this disclosure focuses on the implicity or explicity of the underlying scene representations and the corresponding practicality or usability implications. First, this disclosure discusses a group of methods that model scenes using single-hypothesis surfaces. Representations from this group may tend to be challenging during optimization or they may make strong assumptions limiting their use. Second, this disclosure looks at methods trying to circumvent the latter disadvantages. The second group may model scenes using soft-relaxed surfaces. In other words, these methods may employ volumetric representations that support multiple simultaneous hypotheses for the same surface. Our approach falls into the second group. The embodiments disclosed herein may provide a soft-relaxed, but very explicit representation. Our focus may be on comprehensibility and versatility of the underlying representation thanks to its explicit design.

For models with single surface hypothesis, this disclosure first reviews representations with “strict” surfaces (without geometry soft relaxation). Layered meshes may be special cases designed for novel view synthesis only. That may be why they may be implemented using very regular and simple geometric structures. In other words, they may model a complete scene using only a pyramid of rectangles (multi-plane image (MPI)) or via concentric spheres (MSI). Due to their strong focus and simplicity, they may allow for efficient and high-quality novel view rendering at the same time. One work of such methods reconstructs a scene as explicit MPI with regular depths and plane texels directly consisting of opacity and color values that are rendered using opacity compositing. More recent works are rather hybrid methods with learned neural networks that predict explicit RGBA layers for MPIs or MSIs, respectively assuming a novel viewer in front of the rectangle pyramid or at the center of the concentric spheres. Even more on the implicit end, another conventional work predicts hybrid mesh layers with neural basis functions for the appearance of scene surfaces, since they may better model view-dependent effects than simple RGBA texels. Such learned layered models may interpolate the captured radiance fields of individual scenes well within a limited range of views. However, they may fail to synthesize farther away views and the reconstructed geometry may deviate significantly from the actual surfaces. To maintain the quality, faking view-dependent effects via “ghost” layers may be required, which may prevent manual scene editing.

In contrast to MPIs and MSIs, general mesh-based methods may aim at obtaining a complete and accurate surface reconstruction. Therefore, the results may be much more versatile, but also more difficult to reconstruct. Direct full mesh optimization may be difficult, because the discrete representation may lead to highly non-convex objective functions. In particular, such approaches may be prone to miss necessary gradients during optimization and they may require an initialization that is already close to the global optimum. They may quickly degrade to invalid manifolds and often may not improve the topology during optimization.

Owing to the drawbacks of directly optimized meshes, the community also researched continuous representations that implicitly define scene surfaces and entail a better behavior of the objective function. However, these methods may still assume that the scene can be well reconstructed using clearly defined single-hypothesis surfaces. Depending on where the implicitly defined surface intersects or does not intersect view rays, this may lead to discontinuities in the objective function that are hard to handle. To avoid the local optima originating from these discontinuities, additional constraints from object segmentation masks may be required. Since these masks by themselves are hard or impossible to obtain without human assistance, this may pose a significant limitation. In general, intricate geometry of for example plants or fur as in FIG. 1 may be difficult to represent using SDF- and mesh-based methods. Representing such geometry accurately may often require a resolution with prohibitively high costs. The limitations of methods with single-hypothesis surfaces motivated continuous representations. These approaches may represent geometry using volumetric fields that inherently support multiple surface estimates at the same time to facilitate optimization and also support fine and intricate geometry approximations.

For models with multiple surface hypotheses, this disclosure reviews methods that model scenes with soft-relaxed geometry. We begin with models that are on the very implicit end and continue going towards the very explicit end of scene representations. MLPs that encode the geometry and surface radiance (SLF) of individual scenes volumetrically have become the recently dominant representation. They may model individual scenes via 5D fields consisting of continuous volumetric density for geometry coupled with view-dependent surface radiance for appearance. These compact MLP models may represent surfaces continuously and in a soft-relaxed and statistical manner, which means they may consist of continuous fields that smoothly change during optimization. They may furthermore implement a soft relaxation by allowing to model opaque surfaces as spread out or partially transparent. The latter may allow for multiple surface hypotheses during optimization which may improve convergence by reducing the issue of missing correct gradients. To avoid novel view synthesis errors, they may furthermore approximate fine and intricate surfaces statistically.

Other follow-up works focus on more explicit models by decomposing the previously directly stored scene radiance into more explicit components. By jointly estimating incoming illumination as well as surface geometry and materials, they aim at re-achieving some of the versatility of traditional explicit representations. However, these approaches may either require a very restrictive laboratory capture setup, object masks or they may only work for small-scale scenes with centered objects. Note that object masks may also implicitly prevent intricate materials, e.g., fur or grass, for which it may be difficult to acquire accurate masks in practice. In particular embodiments, our scene models may also directly store the outgoing surface radiance of individual static radiance scenes. However, we may store the outgoing radiance using a sparse hierarchical grid with spherical harmonics (SHs) instead of a black box MLP. Given our simplifying design choice for directly storing and optimizing static SLFs, our models may allow for direct geometry editing and simple transformations of the surface appearance.

The earlier mentioned decomposition approach is an exception regarding two aspects. First, it may not employ MLPs, but a 3D convolutional neural network (CNN) that decodes surface geometry and materials into an explicit and dense voxel grid. Second, it may implement volume rendering using traditional opacity compositing. Compared to our approach, the decomposition approach may be limited to a small-scale laboratory capture setup with black background. It may furthermore require a single point light that coincides with the capturing sensor. Finally, it may be limited by its simple dense grid scene structure and naive scene sampling. In contrast, while our scene models may only have baked-in appearance, we may be able to optimize for more general scenes with less controlled and unknown static radiance fields. To support highly detailed reconstructions, we may present our coarse-to-fine optimization using sparse hierarchical grids with our comparatively more efficient importance sampling scheme.

The hybrid Neural Volumes may represent scenes captured with a light stage using an encoder and decoder network. It may decode a latent code into a regular RGBA voxel grid that is rendered using ray marching and alpha blending. To allow for detailed reconstructions despite the dense regular grids, it may also learn warp fields to unfold compressed learned models. However, ray marching through dense grids may be still inefficient and RGBA grids may not handle view-dependent effects without ghost geometry. More recent and more efficient hybrids with implicit and explicit model parts may also explicitly partition the 3D scene space into cells, but using more efficient and view-dependent sparse voxel grids. This may allow for overall higher model resolution, more efficient scene sampling or faster rendering. These methods may respectively cache computationally expensive volume rendering samples, using a single feature-conditioned MLP or many simple and thus low-cost MLPs distributed over the sparsely allocated grid cells. On the contrary, we employ completely explicit scene models. For multi-resolution rendering, efficient sampling and to limit memory consumption, our models may be built on sparse hierarchical grids. To keep our approach practical and allow for optimizing freely captured and thus uncontrolled scenes, we may also directly cache the SLF of scene surfaces using SHs.

The recently published PlenOctree models may be also more explicit models, which may model individual scenes with static radiance with continuous fields for geometry and appearance that are stored in SVOs. These models may handle view-dependent effects using SHs. However, in contrast to our method, these models may require a multi-step reconstruction pipeline starting from registered images.

In contrast, the embodiments disclosed herein show that it may be feasible to reconstruct 3D scenes directly and uniformly from images with sensor poses and calibrations using an explicit representation. We may achieve high model resolution using SVOs that we gradually build and which we optimize with Adam, but without any implicit, network-based model parts. Since in our case free space and surfaces may be initially completely unknown, our coarse-to-fine optimization with dynamic voxel allocations may be critical to not run out of memory. As important part of the coarse-to-fine optimization, we may present our local plane-based storage and interpolation schemes for the volumetric fields attached to our SVOs. These schemes may allow for approximating thin and fine geometric details, even initially, when only a coarse SVO is available. The explicit coarse-to-fine reconstruction from registered images may furthermore require efficient scene sampling. We may implement an importance sampling scheme that filters sampling points gradually and according to the current geometry estimate. In that way, our method may be not limited by the restrictions coming from an initialization and the SVO structure may dynamically adapt to the scene content without external guide. To avoid blurry transitions from free to occupied space and to obtain clear surface boundaries, our volume rendering may also differ by implementing traditional opacity compositing instead of an exponential transmittance model. Note that we may model geometry not using a density field, but via an opacity field representing soft-relaxed surfaces only and not occupied space. Our geometry representation may be well suited for inverse differentiable rendering, opaque surfaces as well as intricate geometry such as fur. Finally, we may use our SVO structure for LoD interpolation and provide a background model for more flexibility regarding capture setups. In contrast to the PlenOctree work, we may also reconstruct scenes with an unbounded volume, e.g., an outdoor scene with all sensor poses roughly facing the same direction.

In the following, this disclosure presents our scene representation and the corresponding reconstruction algorithm. In particular embodiments, we may reconstruct explicit 3D models from unordered multi-view input images. The computing system may access a set of multi-view images associated with the scene. The multi-view images may depict the scene from a plurality of distinct viewing directions. In particular embodiments, the computing system may determine a plurality of sensor poses and a plurality of calibrations associated with the set of multi-view images. In particular, given an unstructured set of images, we may first run standard structure from motion (SfM) techniques in a preprocess. In particular embodiments, the computing system may determine, for each of the set of multi-view images, a plurality of corners associated with a scene axis-aligned bounding box associated with the scene. To bound the scene parts of interest to be reconstructed, we may manually estimate conservative minimum and maximum corners of the scene axis-aligned bounding box (AABB) using the SfM feature points. We may run our actual reconstruction algorithm with input data consisting of the multi-view images, their sensor poses and calibrations, and the coarse, conservative AABB. In particular embodiments, the computing system may generate a scene model based on the set of multi-view images, the plurality of sensor poses, the plurality of calibrations, and the plurality of corners for each of the set of multi-view images. The view ray may be represented based on the scene model.

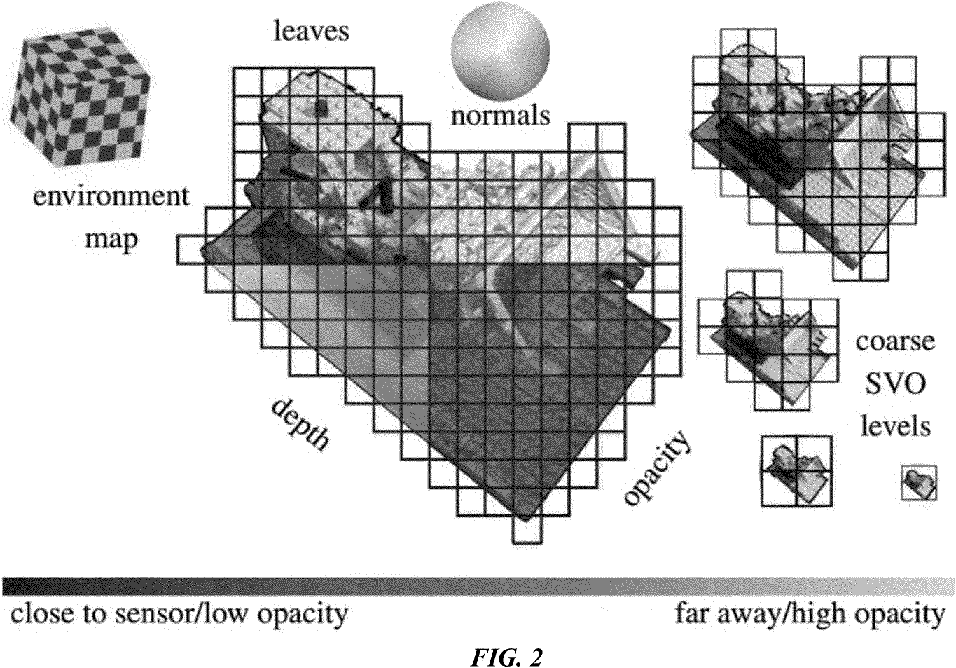

Our reconstruction algorithm may output a scene model comprising an SVO within the given scene AABB. In particular embodiments, the scene model may further comprise one or more of a background cube map comprising a plurality of texels or an environment map representing a plurality of distant scene regions associated with the scene. The output scene model may further comprise a background model, an environment map that complements the SVO. It may represent distant scene regions such as sky for example. FIG. 2 illustrates an example sketch of the scene model. The background model (cube map, left) may complement the SVO. The SVO may store detailed surfaces in its leaves (center) and coarser approximations in its inner nodes (right). Each node may have an opacity and multiple SH parameters.

The SVO may store the “actual” scene. In particular embodiments, the SVO may store one or more of a first volumetric scalar field with opacity defining surface geometry or a second volumetric vector field with spherical harmonics defining a scene SLF. Note that the opacity may model soft-relaxed surfaces and unoccupied space. The scene SLF may contain the total outgoing radiance for each surface point along each hemispherical direction. In particular embodiments, the SVO may comprise a plurality of tree levels. Each of the plurality of tree levels may represent the scene at a specific level of detail. In other words, to support varying scene detail level, our SVO may represent the scene also using inner nodes analogously to mipmap textures. In particular embodiments, the computing system may determine, based on an area of the view ray, one or more levels of detail to use for rendering the image.

Our scene models may be explicit, differentiable and statistical representations. To facilitate robust reconstruction from scratch and editing, the volumetric SVO fields for opacity and outgoing radiance may statistically approximate surfaces, allow for multiple surface hypothesis during optimization contrary to “accurate” surface models and have a clear meaning in contrast to network weights. The model parameters may only go through straightforward constraints ensuring physically meaningful values while an SGD solver may still freely update the parameters. Data transformations may be simpler for explicit scene models since the operations may not need to go through an additional compression layer inherent to compact network-based models. In case of networks, these operations again may require costly optimizations when they target implicitly defined model parts. Equally, initializing our model with a specific state may be simpler. In the embodiments disclosed herein, we may start reconstructions from scratch with a mostly transparent and uninformed random fog to demonstrate the flexibility and robustness of our approach, see FIG. 1. Though, initializing models using results from prior steps such as SfM may also be straightforward. The embodiments disclosed herein may directly store and optimize the radiance outgoing from the scene surfaces using SHs.

Table 1 lists the notation to be used throughout the rest of this disclosure. We abbreviate the notation of sampling points on rays when used within our equations. For example, we denote the opacity of the j-th sampling point on the ray rᵢ at ray depth t_{i,j}, which is located at the 3D location x = rᵢ(t_{i,j}) by o(t_{i,j}). An indexed exemplar element pᵢ surrounded by curly brackets denotes a set. For example, {pi} is a pixel batch and the renderer samples each view ray rᵢ for each optimization batch pixel pᵢ at depths {t_{i,j}}.

TABLE 1

Notation overview

| | | | |
|---|---|---|---|
| Lₒ | SVO SLF | o | SVO opacity field |
| L_{∞} | distant radiance | ô | unconstrained o |
| n(x) | surf. normal at x | C | loss cache |
| {pᵢ} | pixel batch; pixel i | rᵢ | ray of pixel pᵢ |
| X_{c,i} | sensor center of rᵢ | dᵢ | direction of rᵢ |
| o(t_{i,k}) | opacity at rᵢ(t_{i,k}) | {t_{i,j}} | ray batch depths |
| oₚ(pᵢ) | pixel opacity i | {t_{i,k}} | depths subset |
| Lₒ (t_{i,l,} -dᵢ) | SLF at (t_{i,l},-dᵢ ) | {t_{i,l}} | subset of subset |
| Lₚ(pᵢ) | pixel radiance i | Iₚ(pᵢ) | rendered pixel i |
| lₚ(pᵢ) | photo loss i | ${I}_{p}^{\text{gt}} \left({\text{p}}_{i}\right)$ | ground truth i |
| σ(pᵢ) | pixel footprint i | Y_{l,m} | SH basis function |
| ρ | density | C_{l,m} | SH coefficient |

Algorithm 1 describes our method on a high level and details will follow in the remaining disclosure. Our algorithm may first coarsely initialize the new scene model and then gradually extend the SVO (outer loop) according to the repeated optimization of its fields (inner loop).

### Algorithm 1: Hierarchical Optimization

// initialize model & pixel errors cache
1 SVO = createDenseGrid(AABB) // random o, Lₒ
2 L_{∞} = randomEnvMapRadiance( )
3 C = highLossForAllInputPixels( )
// Optimize: inverse differential rendering & SGD
4 For n = 0 to N do
5 {pi} = importanceSample(C) // error driven
6 {rᵢ(t) = X_{c,i} + t · dᵢ } = castRays({pᵢ})
7 {t_{i,j}} = stratifiedSampling(SVO, {rᵢ (t)})
8 {t_{i,k}} = selectRandomly({t_{i,j}}) // uniform
9 {o(t_{i,k})} = getOpacity(SVO, {t_{i,k}})
10 {t_{i,l}}, {o(t_{i,l})} = selectRandomly({t_{i,k}},{o(t_{i,k})})
11 {Lₒ(tᵢ,ₗ, -dᵢ)} = getSLF(SVO, {rᵢ(t)}{t_{i,l}})
12 {Lₚ(pᵢ)}, {oₚ(pᵢ)} = blend({o(t_{i,l})}, {Lₒ(t_{i,l}, -dᵢ)})
13 {Lₚ(pᵢ)} = blend({Lₚ(pᵢ)}, {oₚ(pᵢ)}, {L_{∞}(-dᵢ)})
14 {Iₚ(pᵢ)} = sensorResponses({Lₚ(pᵢ)})
15 $\left\{{l}_{p} \left({\text{p}}_{i}\right)\right\} = \text{loss} \left(\left\{{I}_{p} \left({\text{p}}_{i}\right)\right\} , \left\{{I}_{p}^{\text{gt}} \left({\text{p}}_{i}\right)\right\}\right)$ 16 SVO, L_{∞} = makeStep(SVO, L_{∞}, ∇({lₚ(pᵢ)}))
17 C = update(C, {lₚ(pᵢ)}) // track errors
18 end
// New SVO via opacity o and footprints σ
19 mergeLeaves(SVO) // compact free space
20 if subdivideLeaves(SVO, {σ(pᵢ)}) then
21 resetOptimizer() // due to new unknowns
22 go to line 4
23 end

We may then mainly optimize the parameters of the 3D fields without changing the tree structure using multi-view volumetric inverse differentiable rendering (IDR) and SGD (lines 4 - 18). To this end, we may randomly select small batches of input image pixels using importance sampling (line 5); cast a ray for each selected pixel into the scene (line 6); distribute scene sampling points along each ray using stratified importance sampling (line 7); query the scene SVO for opacity and SLF samples at these ray sampling points (lines 9, 11); accumulate the returned field samples along each ray and also add the visible background radiance using classical opacity compositing to estimate the totally received scene radiance for each selected pixel (lines 12 - 13); map the received radiance to pixel intensities using the response curve of the sensor (line 14), in other words, mapping the pixel radiance associated with SLF and opacity to one or more pixel intensities and, finally, compare the estimated against the input image pixel intensity (line 15) for a model update step (line 16).

Using the gradients of our differentiable volumetric rendering, we may iteratively update the scene model using SGD to fit the scene model parameters to the input images for a fixed model resolution (constant model parameter count). Additionally, we may infrequently update the tree structure. In particular, we may merge or subdivide tree nodes to adapt the resolution based on the current surface geometry estimate. We may do so until the SVO is sufficiently detailed with respect to the input images. The following disclosure describes these algorithmic steps in more detail.

Our explicit scene model may comprise a sparse hierarchical grid, i.e., an SVO. It may store an opacity and RGB SH parameters per node to encode scene surfaces and the radiance leaving them as a scalar and a vector field. The SVO may store both of these fields defined next at each tree level and not only using the leaf nodes to support multiple levels of detail for rendering and optimization. We may assume that everything outside of the AABB that bounds the scene SVO is infinitely far away and therefore represent all remaining scene parts using an environment map implemented as a cube map.

Our SVO may provide a continuous multi-resolution scalar field o. To implement it, the SVO may store a continuous, scalar, volumetric field o : ℝ³ ↦ [0,1] per tree level. Each tree level with its individual field may represent a single LoD. To this end, each tree node, including inner ones, may store 1 floating-point opacity parameter (besides the SLF parameters). Note that inner nodes may hence approximate surfaces at a larger scale. The continuous opacity field o may represent surfaces statistically. Specifically, the opacity o(x) may represent the coverage of a planar slice perpendicular to the radiance traveling through x and thus what percentage of it gets locally absorbed. In other words, it may be a surface property expressing what relative percentage of photons statistically hits the surface at x, e.g., o(x_{free}) = 0 and o(x_{wall}) = 1. As detailed later, the SVO may not only interpolate within 3D space, but also blend between the individual LoD fields to serve scale-extended position queries. In particular embodiments, a scale-extended position query may be a query made at a given position x and a given spatial scale represented as LoD. Only regarding a single LoD and given a query location x, the SVO may interpolate the parameters of the tree nodes surrounding the scene location x. This may result in a raw, unconstrained estimate ô(x) which may need to be constrained to be physically meaningful as explained next, but which may allow the optimizer to freely update the opacity parameters.

Unlike NeRF, which uses the nonlinear Softplus model constraint (activation function) to limit density to the interval [0, ∞), we may constrain opacity to [0, 1] using a variant of tanh:

$$f \left(x\right) = 0.5 ⋅ \left(tanh \left(4 x - 2\right) + 1\right)$$

which may be mostly linear, but may smoothly approach its borders. Our tanh variant may be continuous, mostly linear and quickly approach its borders which may facilitate opacity optimization This may be necessary to prevent the optimizer from oscillating when updating opacity parameters close to the interval borders. Note that it may also approach its borders much faster than Softplus approaches zero. These properties may make it more suitable for free space reconstruction (zero opacity border).

Storing additional parameters for surface normals and optimizing them independently of the surface geometry representation may not work well in practice. For this reason, we may not store, but directly infer surface normals from the raw opacity field gradient via:

$$\text{n} \left(\text{x}\right) = - \frac{∇ \hat{\text{o}} \left(\text{x}\right)}{{\left‖∇ \hat{\text{o}} \left(\text{x}\right)\right‖}_{2}}$$

Our SVO may directly store the “surface appearance”. In particular embodiments, we may store and optimize the outgoing radiance, i.e., the convolution of incoming light with surfaces as a volumetric and view-dependent SLF denoted by Lₒ. Analogous to the surface geometry, the SVO may store an RGB radiance field per LoD tree level: Lₒ : ℝ⁵ ↦ [0,∞)³. In particular embodiments, each node may store low frequency RGB SH coefficients c_{l,m} ∈ ℝ³ besides the opacity parameter. Given a 5D query (x, v) for evaluating the SLF at the 3D scene location x and along the direction v, we may interpolate the SH coefficients of the tree nodes surrounding x resulting in a continuous vector field of SH coefficients {cₗ,ₘ (x)}. Next, we may evaluate the SH basis functions {Yₗ,ₘ} with the interpolated coefficients at x for the radiance traveling direction v using their Cartesian form:

$$\hat{{L}_{o}} \left(\text{x,v}\right) = {\sum }_{l = 0}^{l = b} {\sum }_{m = - l}^{m = l} {c}_{l , m} \left(\text{x}\right) ⋅ {Y}_{l , m} \left(\text{v}\right)$$

whereas

$$\hat{{L}_{o}}$$

∈ ℝ³ denotes the raw, unconstrained RGB radiance, which again may allow the SGD optimizer to freely update the per-node coefficients {cₗ,ₘ}. For memory reasons, we may only store the low frequency components of the SLF in practice, i.e., the first b = 3 bands of each color channel (3 × b × b coefficients per node in total).

To compute the physically meaningful non-negative radiance Lₒ (x, v) after evaluating the SH basis functions for a query (x, v), we may map the unconstrained outgoing radiance L̂ₒ to [0, ∞). To this end, we may avoid any model constraint (activation function) producing invalid negative radiance such as leaky ReLUs, since they may introduce severe model overfitting. Also, the frequently used Softplus and ReLU may both have severe disadvantages for this use case. For these reasons, we may introduce LiLUs (Limited Linear Units) to constrain SLF radiance. LiLUs may be variants of ReLUs with pseudo gradients. In other words, their actual gradient may depend on the state of the input unknown x before (xᵢ) and after its update (xᵢ +1):

$$\begin{matrix}\text{LiLU} \left(x\right) = \left\{\begin{matrix}x \text{if} x \geq 0 \\ 0 \text{otherwise}\end{matrix}\right) \\ \frac{\text{d} \text{LiLU} \left(x\right)}{\text{d} {x}_{i \to i + 1}} = \left\{\begin{matrix}x \text{if} {x}_{i + 1} \geq 0 \\ 0 \text{otherwise}\end{matrix}\right)\end{matrix}$$

which means we practically limit the function domain to [0, ∞). The gradient is zero only for update steps that would result in an invalid state: xᵢ₊₁ < 0; but the gradient is 1 for all valid updates, including the very border: xᵢ = 0 ∧ xᵢ₊₁ ≥ 0. Hence, the constrained variable may be always in the physically valid function image: LiLU(x) ≥ 0. Our LiLUs may be seen as ReLU extensions which may not suffer from complete gradient loss like ReLUs. They may linearly go to zero within the physically valid range making them more suitable for optimizing low radiance surfaces than Softplus or other common constraints that slowly approach the constraint border. Note that the stored model parameters in general may only go through such easy-to-understand constraints and not through black box compression layers, i.e., networks, which may simplify transforming scenes, e.g., for editing. In particular embodiments, the computing system may edit the scene based on one or more user edits on the scene model. Our representation may be suited for tools such as Blender.

In particular embodiments, the computing system may interpolate from the 3D volume. With conventional methods such as NeRF, one may have a continuous 3D coordinate and put it into the network. The network may generate output, which may then change continuously. By contrast, the explicit model disclosed herein may require simplification because the sparse volumetric octree is used for saving memory. One may take a continuous point. The continuous point may fall into some bucket, basically some region of space, e.g., a cubic region of space. Then the way that one may determine the value associated that point may depend on what interpolation kernel is being used. For example, there may be the nearest neighbor kernel. One may take on the value of that voxel and perform neighbor interpolation and this constant within that whole region. But one may get jumps at the boundaries, which is undesirable. Conventional methods may often use linear interpolation, which is cheap and gets rid of the jumps.

In particular embodiments, one may select a sampling point, which may fall somewhere in between eight different voxel centers. Based on how far away the sampling point is from each of the centers, one may take a weighted average of their values weighted by the distances. This may provide a linear interpolation scheme, which may be then defined as a continuous function. But the gradients may be not continuous. As a result, we may use quadratic interpolation. In particular embodiments, the computing system may store parameters to a 3D local plane. The local plane may store, to each cell, the value at the center and potentially the linear gradients. In 3D space, the value may change and the local plane may be used to determine how much the value may change in any direction. Those local planes associated with the neighboring voxels may get interpolated.

In particular embodiments, interpolating each of the plurality of pixel radiances associated with SLF and opacity associated with each of the plurality of voxels may be based on a four-dimensional interpolation based on spatial information and level of detail. In order to support multi-resolution scene models which adapt to the viewing distance, we may store scene data using a tree hierarchy of discrete samples to allow for 4D interpolation (spatial and LoD). In particular embodiments, the SVO may comprise a plurality of tree nodes. The plurality of tree nodes may store the plurality of local planes. Our SVO may store all multi-resolution volumetric fields using local plane-based samples (function value plus spatial gradient) which we interpolate between. Specifically, an SVO may store the opacity o: ℝ⁴ ↦ R and the SLF Lₒ: ℝ⁴ ↦ R^{3xbxb} of a scene. Each of these two multi-resolution fields may be in turn composed of multiple single-resolution fields, one per tree level. Note that this same scheme may be applied to other fields as well. As an example and not by way of limitation, surface materials may be attached to the SVO and interpolated in 4D analogously. In the following, we abstractly refer to such fields as f: ℝ⁴ ↦ R^{D}.

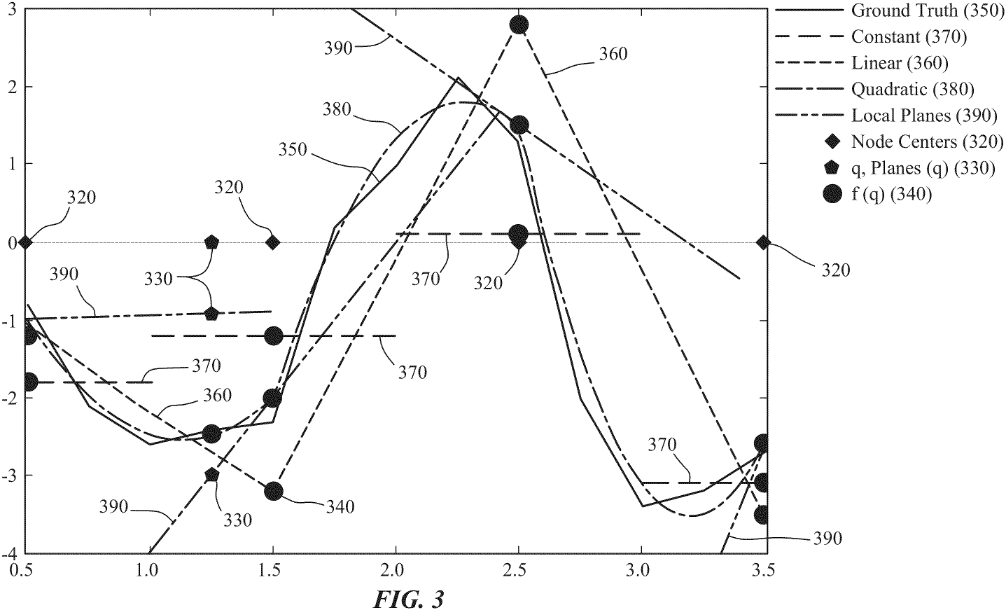

Our quadratic 4D field interpolation for evaluating a field f as in Algorithm 1, lines 9 and 11, may work as follows. When processing an interpolation query f(q) for a scale-extended scene sampling point q = [x^{t}= rᵢ(t), σ(t)]∈ ℝ⁴ on a view ray rᵢ, we may first compute its footprint σ(t) ∈ ℝ⁴ (spatial extend) via back projecting the diameter of the corresponding pixel pᵢ along rᵢ to the depth t. Computing f(q) may then entail interpolating between the discrete local plane-based samples surrounding q. Each tree node j may store one such local plane π_{nⱼ}= [f0(xⱼ, dj)^{t}, ∇f(xⱼ,dⱼ)^{t}] ∈ ℝ⁴. In particular embodiments, each of the plurality of local planes may be based on a four-dimensional coordinate comprising a tree-node center and a depth. The local planes may be addressed using their 4D coordinates consisting of the node center and depth (xⱼ, dⱼ). FIG. 3 illustrates an example 1D field with 4 plane-based samples and the example result of blending them together. In particular embodiments, interpolating the plurality of pixel radiances associated with SLF and opacity associated with the plurality of voxels may comprise determining one or more weights for each of the plurality of pixel radiances based on a distance between the particular sampling point and the local plane associated with that voxel. Accordingly, interpolating the plurality of pixel radiances associated with SLF and opacity associated with the plurality of voxels may be based on the determined weights for each of the plurality of pixel radiances. Based on the distance Δx of q to the surrounding nodes (310), we may evaluate each local plane individually (330) and blend them together for f(q) (340) using weights w. The weights may be also based on the distance Δx (simple linear LoD and trilinear spatial interpolation) making the overall interpolation quadratic. More complex interpolation of discrete samples stored by the scene SVO to represent continuous fields is more expensive, but also achieves a better model fit as shown by the example target 1D scalar field (350). Linear interpolation (360) achieves a much better model fit than simple nearest neighbor lookup (370). However, our quadratic interpolation (380) using optimized local planes (390) provides the best fit. The extrema of the approximating function may need not coincide with the tree node centers. Quadratic interpolation for the field value f(q) (340) at the query q (330) may entail evaluating the local planes and blending the local plane results (390) based on the distance of q from its surrounding nodes (320).

In FIG. 3, the dotted line 490 show the local planes associated with each node. Instead of having a slope of line that is just connecting these two nodes, these local planes may be completely unrelated. They may move independently of each other. The line 380 may reflect interpolating values between those local planes. In linear interpolation, one may have eight voxels that vote on the value for the sampling point. For example, one may average that based on how close the sampling point is to them. If the sampling point in a position relative to a first voxel, the first voxel may vote that the sampling point should have a first value. A second voxel may vote that the sampling point should have a second value. One may interpolate those votes from all the neighboring voxels. In particular embodiments, those votes may be based on a local planer model. As an example and not by way of limitation, one may visualize the scenario where there is a cube divided up into eight other small cubes. Then as a ray passed through it, one may figure out how close is the ray to each of those cubes. Then one may perform interpolation between the values.

FIG. 3 shows a one-dimensional visualization of the interpolation. For each voxel, one may store a local plane. For example, there may be spatial grid voxels that go from 1 to 2 on the 1D line. Another one may go from 2 to 3. The node centers are on 0.5, 1.5, 2.5, and 3.5. The node centers are where the values are stored. The value may be the value of a function, e.g., in the volumetric representations of 3D function. Accordingly, one may want to define a fully continuous function based on these values. One way of doing that is linear interpolation, which connects those dots with a straight line 360. The local planes may be part of the stored values. For example, the line 370 may indicate that the value associated with the sampling point in space. For constant interpolation, the value may be from -0.5 or +0.5. With local planes, there is both a dot and a line going through that dot, which may indicate the stored value comprises both a point and a slope. For example, for node center at 1.5, there may be a point with a value as -2 and a large positive slope. Then at 2.5, the value may be 1.5 and there is a negative slope. Those points in general, may not agree on what the value should be. The quadratic line 380 may show that point is exactly halfway between these two local planes from the two neighboring voxels. This may be equivalent in 3D space. One technical advantage of this may be that one can use higher order, e.g., quadratic cubic interpolation, that uses more voxels to get higher orders of continuity as compared to linear interpolation which provides a continuous function but the gradients are discontinuous. With quadratic interpolation, one may represent the curved surfaces since the confidences in voted values by these voxels are based on distances to the neighboring voxels.

The interpolation may also change the representation. For example, in this 1D case indicated in FIG. 3, there may be one value associated with each voxel so that each node center stores the value at that point, which results in a function. To be able to have the local planes, the values may need to be stored. For the 1D case, the slope of the plane may be considered an extra parameter so there may be two parameters. In 3D space, there may be 3 parameters. One may need the value plus 3 parameters of the local planes, which results in four parameters. Given those parameters and the interpolation function, one may perform the interpolation. Any value stored on the SVO and the interpolation scheme may be then applied to both the spherical harmonic coefficients and the opacity values. It may be viewed as a redefinition of the model that adds these extra parameters, which may change the interpolation function that used to interpolate these 3D local planes, which is further used as part of the rendering function.

As shown in FIG. 3, values may be optimized to result in the ground truth curve 350. All three of these methods, i.e., constant 370, linear 360, and quadratic 380, are trying to approximate that ground truth curve 350. As one may see, the constant one 370 has low performance. The linear interpolation 360 has a decent performance. The local plane interpolation 380 may allow for even better performance, e.g., getting closer to the ground truth curve 350. The quadratic line 380 may indicate that as moving from 1.5 to 2.5, there is one local plane which is reflected by the upward slope and another downward slope, i.e., diverging from the local plane associated with 1.5 and moving closer to the local plane associated with 2.5. In the individual voxels, a point and values required to represent a local plane may be stored, which may then define the local pane in 3D space.

For each of those local planes, the computing system may determine what value to use based on the distance from a 3D point along the ray to the closest point on that local plane. In particular embodiments, the value may depend on the 8 closest voxel values. The computing system may further use a function to take these stored values and output a value for that 3D point along the ray. The computing system may then compute the gradient of the outputted value and use that to optimize the parameters comprising the values and the slopes of the local planes.

In particular embodiments, the computing system may look up the four parameters associated with each neighbor voxel, compute the position of the 3D point relative to those neighbor voxels, compute the point on the local plane at the offset that gives the one vote, weight that vote according to the distance, loop over all 8 neighbor voxels, add up those values of those votes, and then determine the final value. In particular embodiments, the stored values associated with each local plane may be four-dimensional, one value plus three gradient directional values.

In particular embodiments, each of the plurality of voxels may store one or more functions associated with the respective local plane. For a single 4D point query q, the linear blending functions may interpolate between the local planes {π_{nⱼj}|j∈N₁₆(q)} of the 4D 16-node neighborhood N₁₆(q) surrounding q as follows:

$$\begin{matrix}f \left(\text{q}\right) = {\sum }_{j ∈ N 16 \left(\text{q}\right)} {w}_{4 D} \left(\text{q} , {\text{n}}_{j}\right) ⋅ \left({f}_{0} \left({\text{x}}_{j} , {d}_{j}\right) + \text{Δ} \text{x} ⋅ ∇ f \left({\text{x}}_{j} , {d}_{j}\right)\right) \\ {w}_{4 D} \left(\text{q} , {\text{n}}_{j}\right) = {w}_{L o D} \left(σ \left(t\right) , {σ}_{j}\right) ⋅ {w}_{3 D} \left(\text{x} , {\text{x}}_{j}\right)\end{matrix}$$

wherein

$${\text{n}}_{j} = {x}_{j , {σ}_{j}}^{t} ∈ {ℝ}^{4}$$

depicts the center position and diameter of the neighboring tree node j; Δₓ = (x - xⱼ) is the distance vector from the node center to the 3D query position and dⱼ is the tree depth of node j. The blending functions w_{3D} and w_{LoD} respectively provide trilinear and linear weights depending on the distance of the query within Euclidean 3D and within LoD space.

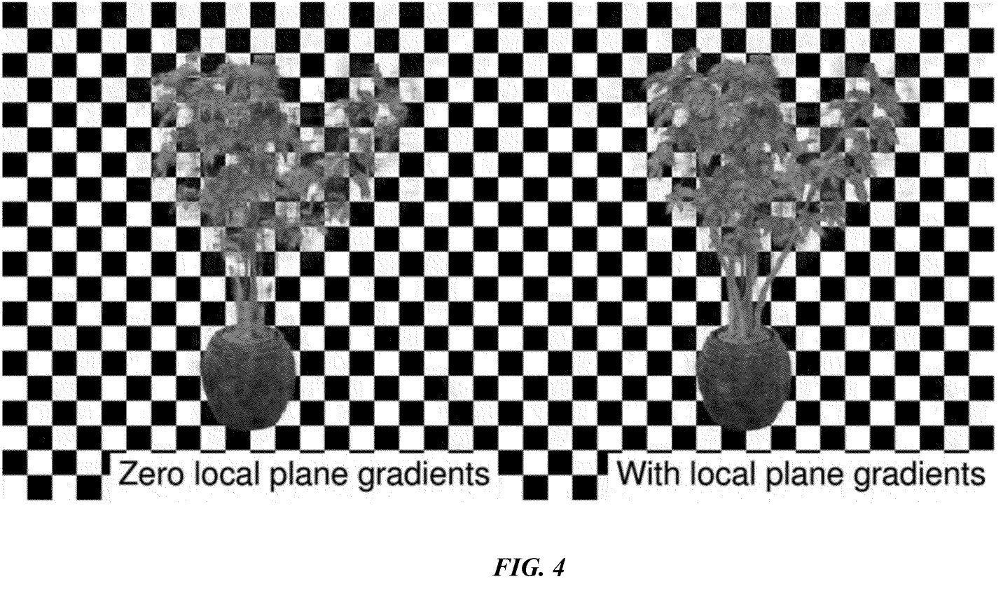

Importantly, this may allow the optimizer to freely place the field extrema in 3D space despite that it updates the pairs of function samples and their local gradients (f₀, ∇f) which may be only stored at the SVO node centers. This is in contrast to only optimizing direct function samples f₀ which may only support function extrema at limited discrete node centers xⱼ shown theoretically by the 1D scalar field example in FIG. 3. FIG. 4 illustrates an example reconstruction with and without local plane-based interpolation of SVO fields. Given only the coarse initial SVO, linear interpolation of only function samples may result in extrema fixed to voxel centers and a worse model fit (left) compared to using the spatial gradients of our local plane samples as sketched by FIG. 4 (right). Allowing the optimizer to continuously position the field extrema (instead of fixing them to the discrete centers of the SVO nodes) may be critical for fine geometry reconstruction when the initial SVO is only coarse as demonstrated by FIG. 4. For regions where the SVO is sparse, a globally constant “border” plane π_{nⱼj} representing free space may substitute the data of all missing neighbors.

A single point query may entail two trilinear interpolations using the blending function w_{3D}, each one for the scene sampling point x and the corresponding 8 surrounding node centers xⱼ at the same tree level dⱼ. We may then linearly blend both 3D interpolation results along the LoD dimension of the tree using the function w_{LoD} . Our 4D interpolation algorithm may determine the two depths dₙ and (dₙ ₋ 1) of the two surrounding 8-neighborhoods (meaning dⱼ = dₙ or dⱼ = dₙ ₋ 1) according to the Nyquist sampling theorem to avoid aliasing:

$${σ}_{n} \leq σ \left(t\right) < 0.5 ⋅ {σ}_{n}$$

whereas a coarser depth and thus a “blurry” query result may be returned if the tree is not deep enough for the query. Note that this LoD-aware sampling scheme may be similar to sampling mipmap textures.

Since our SVO may be limited to a given scene AABB, we may need to represent all captured radiance which emerged from outside the SVO. To this end, we may assume that all scene parts outside the SVO are infinitely far away and model the corresponding radiance using an environment map L_{∞}: ℝ² ↦ ℝ³ which only depends on the radiance traveling direction. Specifically, each model may contain a background cube map that complements the SVO. Cube maps may have the advantage of consisting of locally limited texels. This may prevent oscillations during optimization, in contrast to, for example, an SH-based background for which each single frequency band parameter may influence the whole background. Exactly like for the outgoing radiance Lₒ stored in our SVO, we may constrain the distant radiance L_{∞} using our LiLU-constraint. The background LiLU may process the bilinear interpolation result of the optimized cube map radiance texels.

We may initialize the background with random radiance and the opacity and radiance fields of the SVO with “grayish fog”. The initial opacity field may be mainly transparent to avoid false occlusions that would decrease convergence speed. In other words, opacity parameters may be drawn from a uniform distribution, such that a ray going from the minimum to the maximum scene AABB corner may accumulate only up to 0.05 total opacity. SH coefficients may be respectively drawn from the uniform random distributions [0.2475, 0.5025] and [–0.025, 0.025] for band 0 and all higher bands; background radiance texels from [0, 1]. See FIG. 1A for an example.

To render pixels (Algorithm 1 lines 6 to 14), we may cast a ray rᵢ (t) = x_{c,i} + t • dᵢ into the scene for each pixel pᵢ starting at the camera center x_{c,i} and going along the viewing direction dᵢ. Our renderer may gather all the visible scene radiance along a ray from potentially multiple surfaces to estimate the RGB intensity of the corresponding pixel. For this purpose, we may distribute sample points along each ray within intersected SVO nodes; filter the resulting point set multiple times to make later expensive gradient computations feasible; query the SVO fields and apply our 4D interpolation scheme, see Eq. 5 and accumulate the drawn samples along each ray as detailed next.

In particular embodiments, the computing system may determine a plurality of additional sampling points along the view ray. The computing system may then determine an aggregated pixel radiance for the pixel based on aggregating a plurality of pixel radiances associated with SLF and opacity associated with the plurality of additional sampling points. Accordingly, render the image may be based on the aggregated pixel radiance for the pixel.

In particular embodiments, we may render scenes via an exponential transmittance function:

$$\begin{matrix}{L}_{ρ} \left({x}_{c} , - \text{d}\right) = \text{T} \left({t}_{∞}\right) ⋅ {L}_{∞} \left(- \text{d}\right) {\int }_{{t}_{0}}^{{t}_{∞}} T \left(t\right) ⋅ p \left(t\right) ⋅ {L}_{O} \left(t , - \text{d}\right) d t \\ T \left(t\right) = exp \left(- {\int }_{{t}_{0}}^{t} p \left(\tilde{t}\right) d \tilde{t}\right) .\end{matrix}$$

This formulation is a twice adapted exponential transmittance model for volumetric rendering of participating media only absorbing or emitting radiance. The traditional parts may include the emitted light via the outgoing radiance field Lₒ (t, -d) and the occlusion term T(t) via the extinction coefficients p. The first adaptation may include adding the multiplication by the scene extinction coefficient p within the outer integral and interpreted the outer integral as the expected radiance.

Note that the second adaptation of the volume rendering of Eq. 7, as disclosed herein, may support a broader variety of capture setups than the NeRF formulation using L_{∞}. See for example the different setup of FIG. 1. The extension L_{∞} may add background radiance to the model.

However, we find the aforementioned transmittance model unsuited for our use cases for the following reasons: First, the latter exponential transmittance model assumes that scene geometry consists of uncorrelated particles, which may be not true for opaque surfaces. Second, our goal is modeling soft-relaxed surfaces suited for optimization via inverse differential rendering and SGD and also suited for approximating intricate geometry such as grass. Modeling uncorrelated particles of participating media is not our goal, but we rather estimate coverage by approximated, but structured surfaces. Observed scenes may usually contain mostly free space and opaque surfaces, but not participating media. Finally, there may be no scientific physical background for the mentioned density multiplication of Eq. 7. Note that Eq. 7 may be also too simplistic to model participating media. For these reasons, we may implement our forward rendering model using traditional opacity compositing (alpha blending).

For each ray, we may draw outgoing SLF radiance samples Lₒ (tᵢ, -d) as well as opacity samples o(tⱼ) determining the blending weights for the totally received radiance along a ray:

$$\begin{matrix}{L}_{ρ} \left({x}_{c} , - \text{d}\right) = \text{T} \left({t}_{∞}\right) ⋅ {L}_{∞} \left(- \text{d}\right) + {\sum }_{i = 0}^{N} \left(T \left({t}_{i}\right) - T \left({t}_{i + 1}\right)\right) ⋅ {L}_{O} \left({t}_{i} , - \text{d}\right) \\ T \left({t}_{i}\right) = {\prod }_{j = 0}^{i - 1} \left(1 - o \left({t}_{j}\right)\right)\end{matrix}$$

wherein T models the leftover transparency. Since view rays start close to the sensor and in free space, we may set T(t = 0) to 1. For traditional opacity compositing and in contrast to NeRF, T may directly depend on the relative surface opacity o ∈ [0, 1], see Eq. 1. Similar to layered meshes with transparency, the opacity o may model soft-relaxed surfaces and not filled space. It may be a differentiable coverage term in contrast to discrete opaque mesh surfaces and thus more suited for optimization. However, in contrast to layered representations, the underlying geometry may be continuously defined over 3D space which may facilitate optimizing its exact location. Thanks to these properties, the opacity o may model opaque surfaces, represent partially occluded pixels and it may also approximate intricate fine geometry such as fur, see for example FIG. 1.

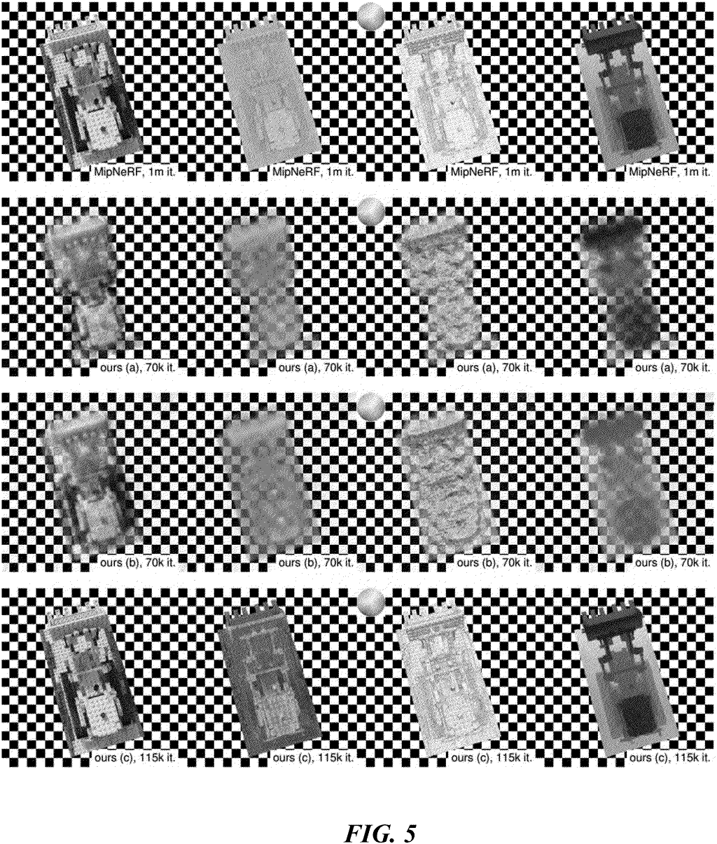

FIG. 5 illustrates an example volume rendering comparison using the bulldozer scene. We compared opacity compositing with the exponential transmittance model of NeRF in FIG. 5. The image rows show the bulldozer scene reconstructed with MipNeRF after 1 million optimization iterations (Eq. 7); ours (a): with the same exponential transmittance and Softplus activation function (Eq. 7); ours (b): with the exponential transmittance and LiLU activation function (Eq. 7, Eq. 4); ours (c): with traditional opacity compositing after 85k iterations (Eq. 8). Ours (a) and (b) did not converge with density fields accurate enough for SVO node subdivisions, even after 70k optimization iterations. Besides the fact that opacity compositing is simpler and cheaper to evaluate, it may consistently help the optimizer reconstruct actually opaque surfaces instead of blurry and semi-transparent results produced by the exponential transmittance model. However, the potentially more opaque opacity field o is, the harder to optimize in case of false occlusions and thus missing gradients for occluded surfaces. To alleviate the lack of gradients leading to a correct reconstruction (besides efficiency reasons), we may devise a custom scene sampling strategy for optimizing our models.

Efficient and robust scene sampling may be critical for explicit high resolution scene reconstruction via inverse differentiable rendering. It may be especially important for explicit models that are less compact than implicit neural network-based alternatives. The 3D locations of scene surfaces may have to be sufficiently sampled, which may be difficult when their locations are initially completely unknown. For example, there may need to be enough samples along each ray to not miss surfaces intersected by a ray, especially thin structures. False intermediate free space where surfaces still have to emerge during optimization may also need to be sampled densely enough. However, at the same time, the number of drawn scene sampling points may have to be kept low to limit the costs of following rendering and gradient computations. We may tackle this challenging problem using the following scene sampling scheme.

To tackle the challenging scene sampling requirements, our renderer may sample scene models via multiple steps. First, the renderer may draw uninformed samples from a uniform distribution along each ray using stratified sampling, see Algorithm 1 line 7. Second, it may filter samples randomly and only keep a subset, see line 8. We may exploit the fact that Adam keeps track of gradient histories. This may allow for deferring dense ray sampling over multiple optimization iterations instead of densely sampling each ray within each single iteration. Third, the renderer may filter the ray sampling points again after it queried the SVO for opacity samples to keep samples which are likely close to the true scene surfaces, see line 10. The renderer may query the scene SVO for rays through 3 example input pixels at different mipmap pyramid levels. Only the intersected SVO nodes with side lengths fitting to the pixel back projections may contain sampling points

For each ray rᵢ, the renderer may create sampling points {t_{i,j}} via stratified sampling, see Algorithm 1 line 7; it may randomly distribute these sampling points within each SVO node intersected by rᵢ while ensuring a sampling density that depends on the side length of the intersected node as detailed next. To account for the projective nature of capturing devices and the spatially varying LoD within an SVO, while marching along a ray rᵢ, the renderer may go down the SVO to nodes of depth dₙ with side length σₙ that fit to the SVO sampling rate σ(ₜ) at the current ray sampling depth t. In this case, the SVO sampling rate σ(t) may be the back projection of the diameter of the corresponding pixel. The ideal tree depth dₙ for finding the node to be sampled which has the highest LoD and is still free of aliasing may be then inferred using the Nyquist sampling theorem in the same manner as for general SVO field queries via Eq. 6. If there is no tree node allocated at this depth, the corresponding ray depth interval may be treated as free space. Though in the special case, if the SVO is still built up and if the traversal reached the global maximum depth of the SVO, a coarser higher level node may be returned for sampling and not treated as free space. This means we may handle the ray query with coarse nodes if not possible otherwise and with more detailed nodes at later optimization iterations. The renderer may sample each node in the intersected set according to the node sizes {σₘ} which may vary and increase with depth. In particular embodiments, for a node nₘ to be sampled, the renderer may uniformly draw a constant number of N samples per side length σₘ within the intersection interval of rᵢ with nₘ. The constant relative sampling density s(nₘ) = N/σₘ may result in a varying spatial sampling density that decreases with depth similar to inverse depth sampling. It may adapt to the back projected pixel diameter σ(t) and according to the spatially varying available SVO LoD. The renderer may filter the resulting sampling points {t_{i,j}} next.

The renderer may have a maximum budget for the number of sample points per ray which it may enforce via deferred stochastic filtering of the sampling points {t_{i,j}} from stratified sampling, see Algorithm 1 line 8. Varying sample counts per ray may be more difficult to process in parallel and storing their shading and gradients data in limited GPU memory may be also more challenging compared to a capped budget for scene sampling points. Skipping sampling points randomly during optimization may induce noise on the loss gradients which SGD is per design robust against however. Also note that overall convergence may be higher since intermediate false occluders may be skipped randomly. They may otherwise potentially consistently occlude sampling points at the true surface locations and result in missing gradients required for correct reconstruction. Hence, the renderer may randomly (uniformly) select a subset of sampling points for each ray rᵢ with a sample count exceeding a given budget Nₘₐₓ and produce a limited set of ray sampling points {t_{i,k}} ⊂ {t_{i,j}}.

The renderer may then filter the already limited sampling points {t_{i,k}} again according to the current scene geometry estimate. After querying the SVO opacity via our 4D interpolation scheme of Eq. 5 with the limited ray sampling points {t_{i,k}}, see Algorithm 1 line 9, the renderer may reduce the number of samples per ray using importance sampling to N_{max,o} < Nₘₐₓ. It may prefer samples {t_{i,l}} ⊂ {t_{i,k}}, which may be probably close to the true surfaces. In particular embodiments, it may assign a sampling weight

$${w}_{s , r} \left({t}_{i , k}\right) = c + o \left({t}_{i , k}\right)$$

to each sampling point. The user-defined constant c = 0.05 may ensure that the whole ray is sampled at least infrequently to handle intermediate false free space regions. Finally, the renderer may use the two times reduced samples t_{i,l} to retrieve outgoing SLF radiance samples from the SVO, see Algorithm 1 line 11. We may set the number of samples per node edge length to N = 8 and limit the per-ray sample sets to Nₘₐₓ = 256 and N_{max,o} = 32 during optimization. Note that this stochastic limiting may be mainly required to limit the costs of the gradients computations during optimization. It may be optional for only rendering once the SVO is built; when no loss gradients are computed and when the SVO nodes tightly bound the observed surfaces and thus greatly limit the ray sampling intervals.

Sampling along rays may be simpler for opacity than for density fields. The advantage of opacity fields may be that they directly model the relative reduction of radiance. Each opacity sample may be independent of the distance to its neighboring sampling points. This may be similar to rendering fragments of layered mesh representations. As opposed to this, sampling and optimizing density fields may not only require estimating correct extinction coefficients. But also finding the right step sizes between samples may be critical. Nevertheless, our opacity fields may theoretically be converted to equivalent density fields.

Our method may iteratively reconstruct a scene model from scratch using SGD and importance pixel sampling in a coarse-to-fine manner by comparing the given input images against differentiable renderings of that model from the same view and updating it according to the resulting model loss and gradients. Besides photo consistency loss from comparing renderings against the input images, we may employ light priors to improve convergence, see Eq. 10. Our method may start reconstruction with a dense but coarse SVO grid that it attaches uninformed 3D fields to. It may then mainly optimize these fields with the SVO structure being fixed. Further, it may infrequently update the SVO structure to exploit free space and adapt the resolution given the current fields and then restart field optimization for a more detailed result. Note that representing geometry using opacity fields may be a soft relaxation similar to layered mesh representations. Both may employ differentiable opacity parameters defining local coverage and radiance reduction directly. But otherwise, our opacity fields may be continuously defined over 3D space and also provide fully differentiable surface locations like density fields.

During SGD, see Algorithm 1 line 15, we may compute the model loss for small batches of image pixels and SVO nodes. The objective function of our optimization problem may contain multiple priors besides a photo consistency term to avoid convergence at solutions that exhibit low photo consistency error, but also physically implausible surface geometry. Ambiguous reconstruction cases may cause such solutions if only photo consistency is optimized for. As an example and not by way of limitation, scenes might not have been captured sufficiently or there can be surfaces with little texture which do not sufficiently constrain their underlying geometry. To avoid these local minima, we may suggest SVO priors defined on tree nodes. They may prefer smooth and physically meaningful results. The priors may also prevent those parameters derange if they lack correct gradients intermediately or consistently.

In particular embodiments, for a random batch of pixels {pᵢ} and random batch of SVO nodes {nⱼ}, we may evaluate the objective function:

$$\begin{matrix}{l}_{Θ} \left(\left\{{p}_{i}\right\} , \left\{{n}_{j}\right\}\right) = \frac{1}{\left|{p}_{i}\right|} {\sum }_{\text{i}} \left[\left({p}_{i}\right)\right] \\ + \frac{1}{\left|{n}_{j}\right|} ⋅ \left[{l}_{3 D} \left(\left\{{n}_{j}\right\}\right) + {l}_{o D} \left(\left\{{n}_{j}\right\}\right) + {l}_{0} \left(\left\{{n}_{j}\right\}\right)\right]\end{matrix}$$

whereas the individual loss terms are as follows. The squared pixel photo consistency loss compares pixel intensity differences per color channel:

$${l}_{p} \left({p}_{i}\right) = {Σ}_{c} {\left‖{I}_{p} \left({p}_{i} , c\right) - {I}_{p}^{g t} \left({p}_{i} , c\right)\right‖}^{2} .$$

The SVO priors l_{3D}, l_{oD}, lₙ and l₀ are losses preferring local smoothness in 3D space, local smoothness along the LoD dimension, as well as zero opacity and radiance for sparse models without clutter.

The photo consistency and prior losses may be both normalized by their individual batch size for comparability. As an example and not by way of limitation, we set the batch size to 4096 for both batch types in our experiments (pixels and nodes). Note that we may also employ background priors enforcing local smoothness and zero radiance. They may be analogous to their SVO counterparts and thus we omit them here for brevity.

The objective function contains the following priors:

$${l}_{3 D} \left(\left\{{n}_{j}\right\}\right) = {λ}_{3 d} ⋅ {\sum }_{n j} {\sum }_{{N}_{k} ε {N}_{6} \left({n}_{j}\right)} {l}_{1} \left(f \left({x}_{j} , {d}_{j}\right) - f \left({x}_{k} , {d}_{j}\right)\right)$$

$${l}_{L o D} \left(\left\{{n}_{j}\right\}\right) = {λ}_{L o D} ⋅ {\sum }_{{n}_{j}} {l}_{1} \left(f \left({\tilde{x}}_{j} , {d}_{j}\right) - f \left({\tilde{x}}_{j} , {d}_{j} + 1\right)\right)$$

$${l}_{0} \left(\left\{{n}_{j}\right\}\right) = {λ}_{0} ⋅ {\sum }_{{n}_{j}} {l}_{1} \left(f \left({\tilde{x}}_{j} , {d}_{j}\right)\right)$$

which may regularize the SVO node parameters. Eq. 11 may prefer local smoothness. Eq. 12 may enforce smoothness between tree levels. Eq. 13 may punish deranging parameters by preferring zero density and radiance. Note that we may apply the SVO priors to the opacity and the outgoing radiance field Lₒ. We may also analogously apply local smoothness and low radiance priors to the background cube map texels which we omit here for brevity. Hereby, N₆(nⱼ) are the six axis aligned neighbors of node nⱼ ; l₁1 is the smooth Huber loss function; xⱼ is the center of node nⱼ ; x̃ⱼ is a random 3D position within the scope of node j and dⱼ is its depth within the tree. We may choose the nodes {nⱼ} to which the priors are applied as detailed next. Further, we may uniformly set the strength of all priors via λ = 1 - 3 for all the experiments shown here.

Our stochastic priors may improve convergence via normalized random batches. For the SVO priors, we may simply randomly choose SVO nodes (and neighborhoods). We may directly apply the rendering priors to the rays of the random input pixel batches (that are already available for reducing photo consistency errors). The priors hence may similarly work to the data term that is based on the random input pixel batches. Applying the priors every iteration to every ray or voxel may result in very consistent and hence overly strong priors. Contrary, our random prior batches may facilitate convergence, but may be also treated as noisy outliers in cases where they do not fit, since the stochastic priors are tracked like the data term by Adam’s gradient histories. As an example and not by way of limitation, applying local smoothness to an edge infrequently may result in wrong, but inconsistent gradients Adam is robust against. Additionally, the costs of our stochastic priors may scale with the batch and not the model size, making them more suitable for complex models with many parameters.

The embodiments disclosed herein investigated different solvers for fitting our scene models against registered images of a scene. Higher order solvers such as Levenberg-Marquardt optimization algorithm (LM), limited-memory BFGS (LBFGS) or preconditioned conjugate gradients (PCG) may be either too expensive given the high number of unknowns of our scene models or they may fail to reconstruct scenes from scratch. That means they may converge in a bad local optimum due to our optimization problems being highly non-convex and due to starting far from the globally optimal solution while making simplifying assumptions to approximate the inverse Hessian which are not applicable in our case. Therefore, the embodiments disclosed herein decided for a relatively cheap SGD-based optimizer which may be still powerful enough for the targeted non-convex and high-dimensional objective functions. In particular embodiments, we employed Adam for all our experiments and ran it with the recommended settings.

Our method may reconstruct scene models in a coarse-to-fine manner. It may start with a dense, but coarse scene grid, i.e., a full, shallow SVO. The tree may then gradually become sparser by merging of nodes or more detailed thanks to new leaves. The SVO structure may change infrequently depending on its attached fields after optimizing them for a fixed SVO structure as shown by the outer loop of Algorithm 1.

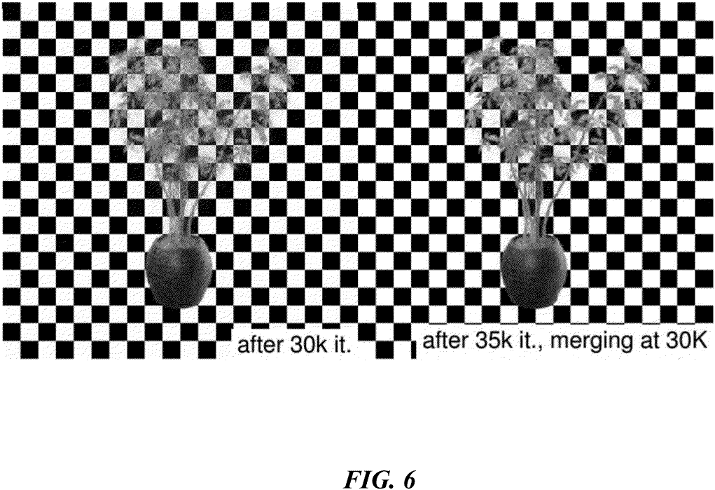

FIG. 6 illustrates example intermediate ficus scene models after optimizing the SVO fields showing the initial dense SVO (left) and the SVO sparsified after 30k mini batch iterations (right). We may merge nodes in free space to save memory and reduce rendering costs. Merging nodes may also considerably increase the quality of the view ray sampling point distributions as demonstrated by FIG. 6. By means of the optimized opacity field, we may determine the set of nodes {nᵣ} required for rendering using Dijkstra searches that we run on each tree level’s 27-neighborhood graph. The Dijkstra search is hysteresis-based similarly to the Canny edge detector for robustness. First, we may sample each tree node using a regular pattern of 8³ sampling points and determine its maximum opacity oₘₐₓ(j). Second, we may start a Dijkstra search on each unvisited node j with oₘₐₓ(j) ≥ 0.75 and only expand the search to nodes {k} with oₘₐₓ(j) ≥ 0.075. Third, a 27-neighborhood dilation may augment the set of all visited nodes to ensure complete opacity function ramps from free to occupied space. The resulting set of {nᵣ} may then define nodes which may not be discarded. In particular embodiments, we may either keep all 8 children of an SVO node if any child is within {nᵣ} or discard all of them.

To subdivide nodes, we may first find the set of required nodes {nᵣ} in the same manner as for merging. However, a leaf node within {nᵣ} may be only eligible for subdivision if the subdivision does not induce under sampling. That means there may be an input pixel with small enough 3D footprint such that the Nyquist sampling theorem still holds (similar to Eq. 6). The footprint σ(t) from back projecting the pixel to the depth t of the node may define the sampling rate and the node edge length may define the signal rate. If a leaf is within {nᵣ} and does not induce aliasing, we may allocate all of its 8 children. The SVO may fill all new leaf nodes with the 3D-interpolated data of their parents resulting in a smooth initialization with less block artifacts compared to copying parent values. Our method may afterwards optimize the new and smoothed, but also more detailed SVO using SGD again as denoted in the inner loop of Algorithm 1. The refinement may finally stop if there are no new leaf nodes according to the Nyquist sampling theorem.

To facilitate convergence, our method may employ Gaussian pyramids of the input images and importance sampling as described next. For better optimization convergence and before the actual optimization, we may compute a complete Gaussian (mipmap) pyramid of each input image. We may then randomly select pixels from all input image pyramids to simultaneously optimize the whole SVO at multiple levels of detail. Coarser input pixels from higher mipmap levels may have a larger footprint and thus help optimize inner or higher level SVO nodes as in the sampling scheme of Eq. 6.

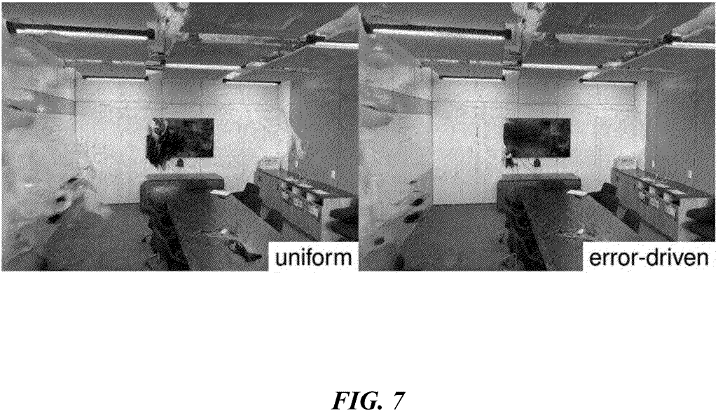

For faster convergence where scene reconstruction has not finished yet, we may implement importance sampling. FIG. 7 illustrates an example pixel sampling comparison using the NeRF room scene for a test view after 175k iterations. We may prefer pixels with high photo consistency error as depicted by Algorithm 1 line 5 and demonstrated using FIG. 7. The sampling weights are basically the per-pixel maxima of the color channel errors: wₛ,ₚ(pᵢ) =

$$m a {x}_{c} \left({\left‖{I}_{p} \left({p}_{i} , c\right) - {I}_{p}^{g t} \left({p}_{i} , c\right)\right‖}^{2}\right) + c .$$

Similarly to the ray sampling of Eq. 9, we may add a small constant c = 0.05 to also sample low error pixels infrequently and prevent oscillating errors. To implement this scheme, a loss cache C may steer the importance sampler, see line 3. It may cache running error averages of the input pixels via the photo consistency loss of the pixel batches {lₚ (pᵢ) }, see line 17. The cache may store prefix sum offsets of the sampling weights {w_{s,p} (p)} for fast random pixel selection whereas it updates these offsets infrequently, i.e., every 5000 iterations. Further, we may only store coarse error cache data, meaning only at higher image mipmap pyramid levels for efficiency reasons and to broaden the image sampling area of the importance sampler. If a low mipmap level is selected where multiple fine pixels fall into the same coarse pixel with a single running average error, then the sampler may uniformly select between all fine pixels.

In the following, we evaluate individual contributions of our approach and show that our reconstructed explicit models are comparable to state-of-the-art implicit alternatives. Our models may converge faster in general, but their implicit competitors may generally converge at the best solutions after many more iterations.

We compared direct opacity compositing against the exponential transmittance formulation. When employing the exponential transmittance formulation (Eq. 7), our explicit model may be less accurate compared to their opacity compositing-based alternatives from (Eq. 8). The density field may be smeared out and much blurrier than the opacity field. The density fields may be also less suited for our hierarchical refinement as empty nodes are more difficult to distinguish from SVO nodes in occupied space. Interestingly, the MLP representation of MipNeRF may be not affected in the same way. The MipNeRF models of the synthetic scenes may have low photo consistency error and accurate underlying geometry despite the exponential transmittance model. However, the MipNeRF models may need many more mini batch optimization iterations.

First, the comparison of FIG. 4 may demonstrate the importance of our quadratic 4D interpolation when sampling scenes for scale-augmented 3D points. Interpolating between local planes (field function samples plus local gradients) may allow the optimizer to select continuous instead of limited discrete 3D positions for the extrema of the fields. It may hence better fit the scene model to the input images when voxels are only coarse. This may be especially beneficial for fine and intricate geometry like from the shown ficus. Second, the error-driven importance sampling may improve convergence as demonstrated by FIG. 7.

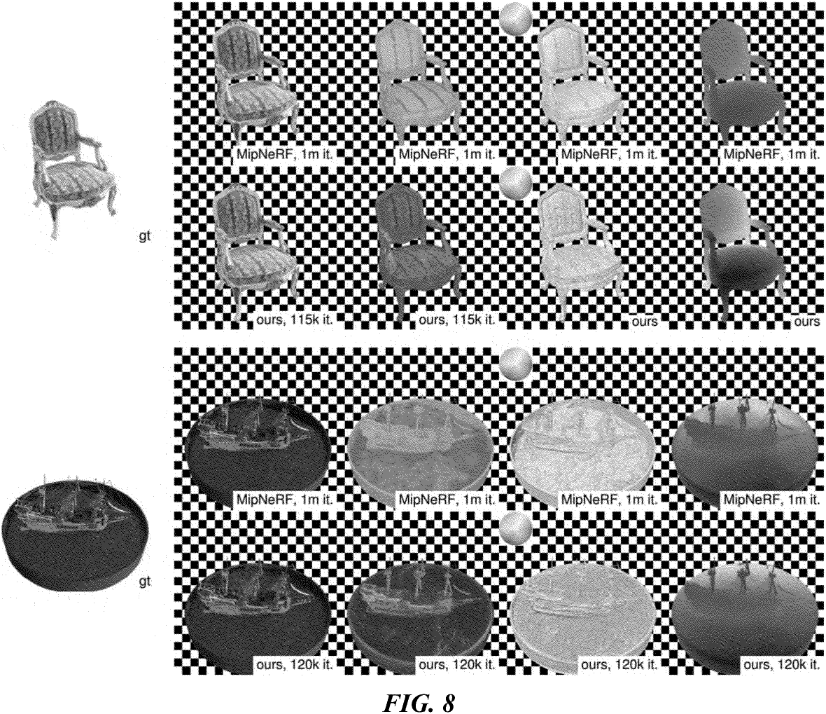

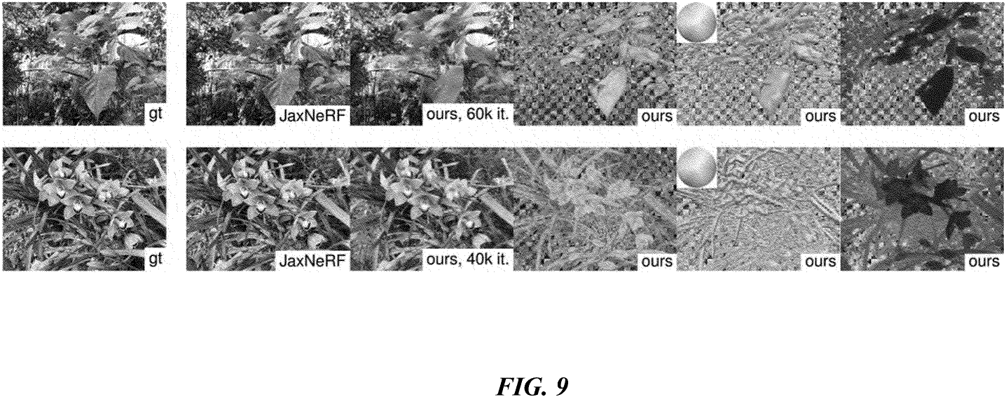

FIG. 8 illustrates example reconstructions for exemplary synthetic scenes from NeRF. FIG. 8 shows qualitative evaluation using MipNeRF and ours on the synthetic chair and ship scene with (from left to right): original hold-out ground truth image; photo-realistic reconstruction; density (MipNeRF) or opacity (ours); surface normals and depth map visualization. As may be seen, our method performs similar to MipNeRF. Note that our algorithm may be able to reconstruct many of the fine and thin structures like the ship ropes despite that it starts with a coarse grid only. FIG. 9 illustrates an example qualitative evaluation using JaxNeRF and ours on the leaves and orchid scene. FIG. 9 shows (from left to right): original hold-out ground truth images; photo-realistic reconstructions (JaxNeRF and ours); renderings of opacity, surface normal, and depths (ours only). FIG. 9 demonstrates that our approach may also reconstruct large-scale outdoor scenes with complex scene geometry. Though, our models may exhibit fewer details than JaxNeRF (improved original NeRF).

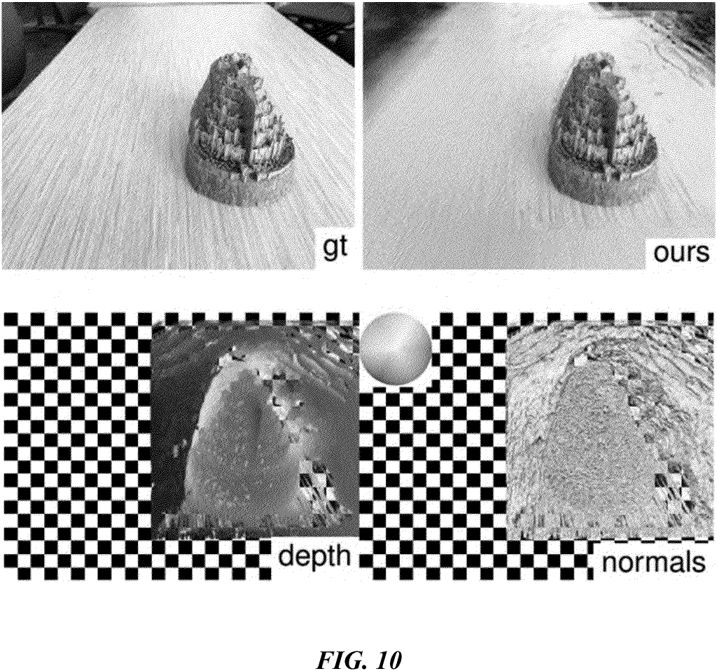

Table 2 shows that our method may reconstruct high-quality models that are similar to the state-of-the-art implicit MipNeRF approach. Our models perform slightly worse due to view ray sampling noise and due to the fact that they may not capture high-frequency reflections well. Our models consistently perform worse mainly due to the limiting initial SVO creation and due to the fact that we do not dynamically adapt the user-defined scene AABB. FIG. 10 illustrates an example reconstruction of the object of interest inside the scene AABB by our method. FIG. 10 shows fortress scene reconstruction after 170k iterations based on a manually defined tight scene AABB. However, it is surrounded by clutter that the optimizer added to account for the table outside the AABB which cannot be represented well by the environment map.

TABLE 2

Quantitative novel view synthesis comparison of the proposed explicit models (ours) with MipNeRF on the synthetic NeRF scenes

| | SSIM↑ | | PSNR↑ | |
|---|---|---|---|---|
| | MipNeRF | ours | MipNeRF | ours |
| Chair | 35.19 | 28.73 | 0.9891 | 0.9887 |
| Drums | 26.16 | 24.22 | 0.9597 | 0.9657 |
| Ficus | 32.34 | 27.36 | 0.9861 | 0.9864 |
| Hot dog | 37.18 | 31.71 | 0.9921 | 0.9883 |
| Bulldozer | 35.76 | 28.38 | 0.9903 | 0.9817 |
| Materials | 31.50 | 26.29 | 0.9808 | 0.9662 |
| Mic | 36.22 | 30.23 | 0.9941 | 0.9888 |
| Ship | 29.33 | 25.38 | 0.9297 | 0.9409 |
| Average | 32.96 | 27.79 | 0.9777 | 0.9758 |

In the following, this disclosure shows additional results for specific parts of our method like changing model parameters, such as the SH band count, as well as more quantitative and qualitative comparisons of our method against state-of-the-art implicit alternatives.

Table 3 compares our approach regarding learned perceptual image patch similarity (LPIPS) on the NeRF scenes where MipNeRF performs better.

TABLE 3

LPIPS comparison using the proposed explicit models (ours) with MipNeRF on example scenes

| LPIPS↓ | MipNeRF | ours |
|---|---|---|
| Chair | 0.013 | 0.036 |
| Drums | 0.064 | 0.072 |
| Ficus | 0.021 | 0.045 |
| Hot dog | 0.020 | 0.061 |
| Bulldozer | 0.015 | 0.043 |
| Materials | 0.027 | 0.078 |
| Mic | 0.006 | 0.027 |
| Ship | 0.128 | 0.183 |
| Average | 0.0367 | 0.0679 |

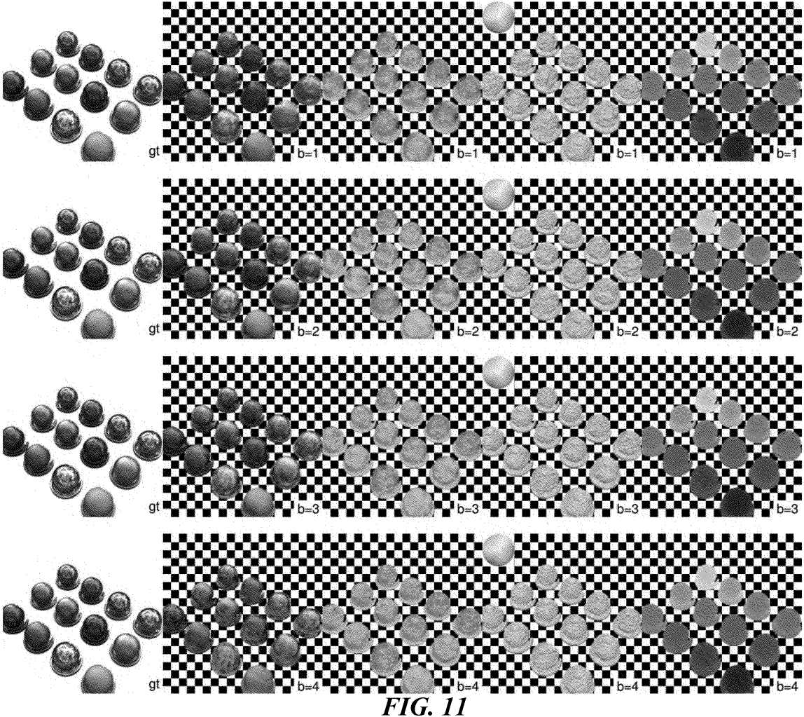

FIG. 11 illustrates example differences in reconstruction quality for varying numbers of SH bands to represent outgoing surface radiance. FIG. 11 shows SH band count comparison with reconstructed models after 30 k mini batch iterations on the synthetic materials scene (from left to right): hold-out ground truth image (ground-truth), photo-realistic reconstruction, opacity, surface normals and depth map. Increasing the SH band count first increases reconstruction quality. However, the quality decreases again starting with 4 bands. We presume that optimization convergence decreases due to the higher degree of the underlying polynomials which are not localized in angular space. The frequency-based design of the SHs presumably compounds optimization as each drawn radiance sample gradient influences all SH coefficients.

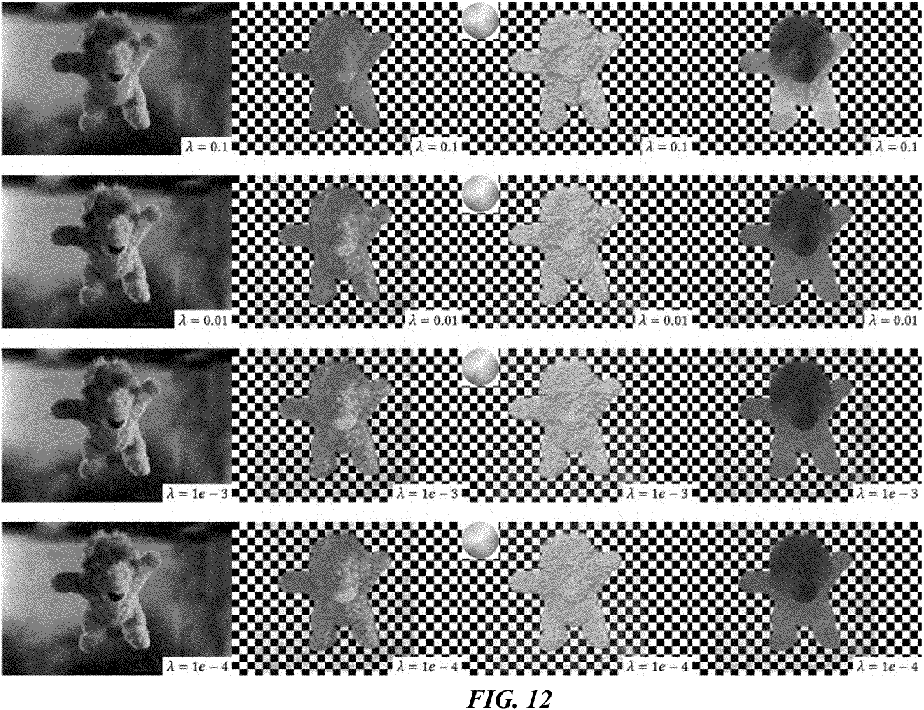

FIG. 12 illustrates an example comparison of reconstruction results for varying prior strengths. Varying prior strengths experiment show Lion reconstructions after 50 k iterations with decreasing lambda factors and thus also decreasing model smoothness and increasing free space clutter from top to bottom. They induce overly smooth results for λ= 0.1 and λ = 0.01 and have almost no impact for λ = 1e - 4. Note that the zero-opacity prior also reduces the initial clutter in free space more for higher λ values. Thus, we generally set λ = 1e - 3 for our experiments.

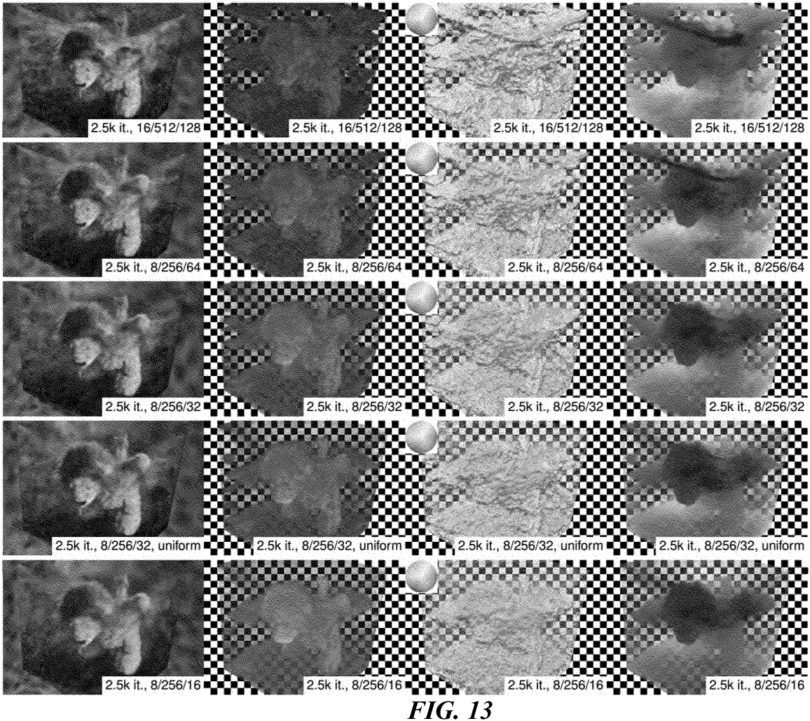

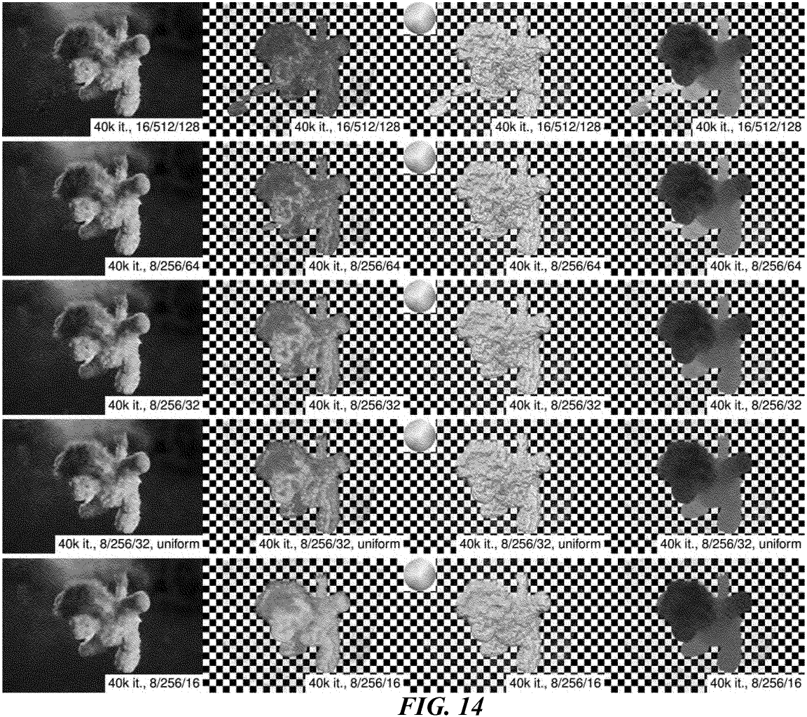

We investigated the influence of different sampling budgets during optimization. FIG. 13 illustrates an example scene sampling influence on results after 2.5 k iterations of the Lion scene with varying sampling budgets. The varying sampling budgets, denoted as N/Nₘₐₓ/N_{max,o} which respectively are the samples per node edge length; maximum number of samples per ray after uninformed and after opacity-based filtering. FIG. 14 illustrates example scene sampling influence on results of the Lion scene after 40 k iterations and with varying sampling budgets. The varying sampling budgets are the same as in FIG. 14, denoted as N/Nₘₐₓ/N_{max,o}. FIG. 13 and FIG. 14 demonstrate that Adam may be very robust against the noise introduced by only small sampling budgets. Interestingly, the reconstructions are actually better (less false clutter in free space) when only employing smaller and cheaper sampling budgets. We presume that small sampling budgets may increase the probability of sampling around false occluders which may mitigate the lack of required gradients they induce on occluded voxels. Note that smaller sampling budgets partially blur the fields and result in voxels within objects being occupied despite our zero-opacity prior. Uniform instead of stratified sampling within a ray-intersected node (4th row only) reduces reconstruction quality only little in this case.

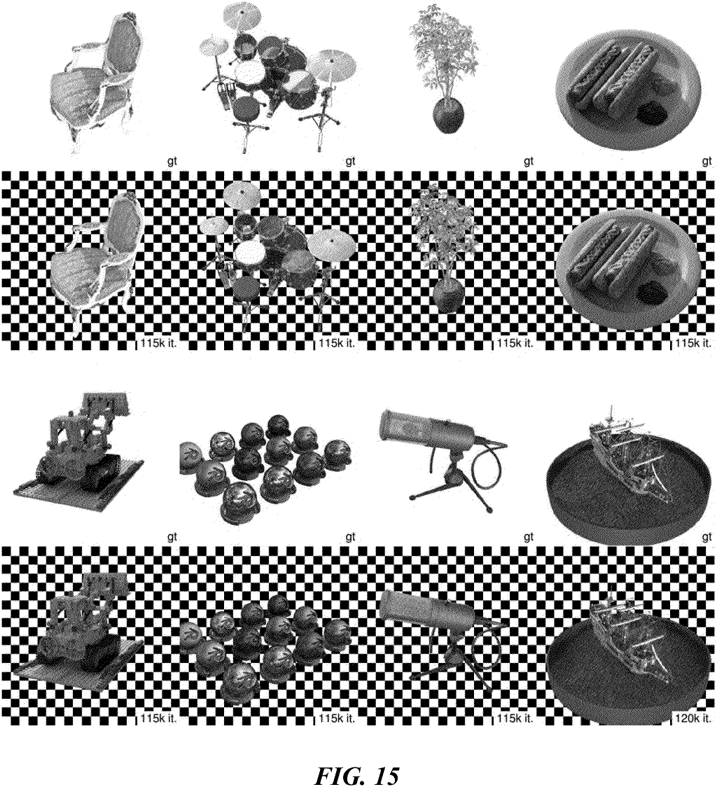

FIG. 15 illustrates an example qualitative evaluation using an overview of our results for all of the synthetic NeRF scenes. The overview of FIG. 15 demonstrates the novel view synthesis performance of our method for all of the synthetic NeRF scenes. Our method reconstructs the scenes within comparably few optimization iterations and with high quality that is similar to state-of-the-art implicit approaches like MipNeRF. However, the surface light field based on low frequency SHs is clearly not able to represent sharp reflections as for example the drums scene comparison shows.

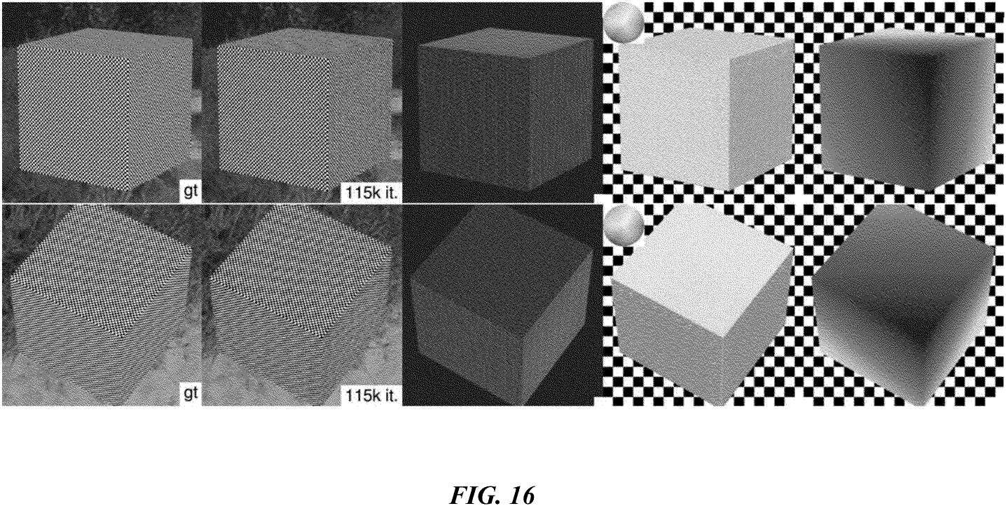

FIG. 16 illustrates an example robustness experiment on a synthetic scene. The synthetic scene consists of an axis-aligned checkered cube flying inside a beach environment map showing (left to right): hold out ground truth; photo realistic reconstruction; photo consistency errors; surface normals and depths. We tested the robustness of our method against fine details with opposing surface radiance using the synthetic checkered cube scene shown in FIG. 16. Our method is able to reconstruct the checker pattern and does not fail with an average gray surface estimate despite the SGD-based optimization.

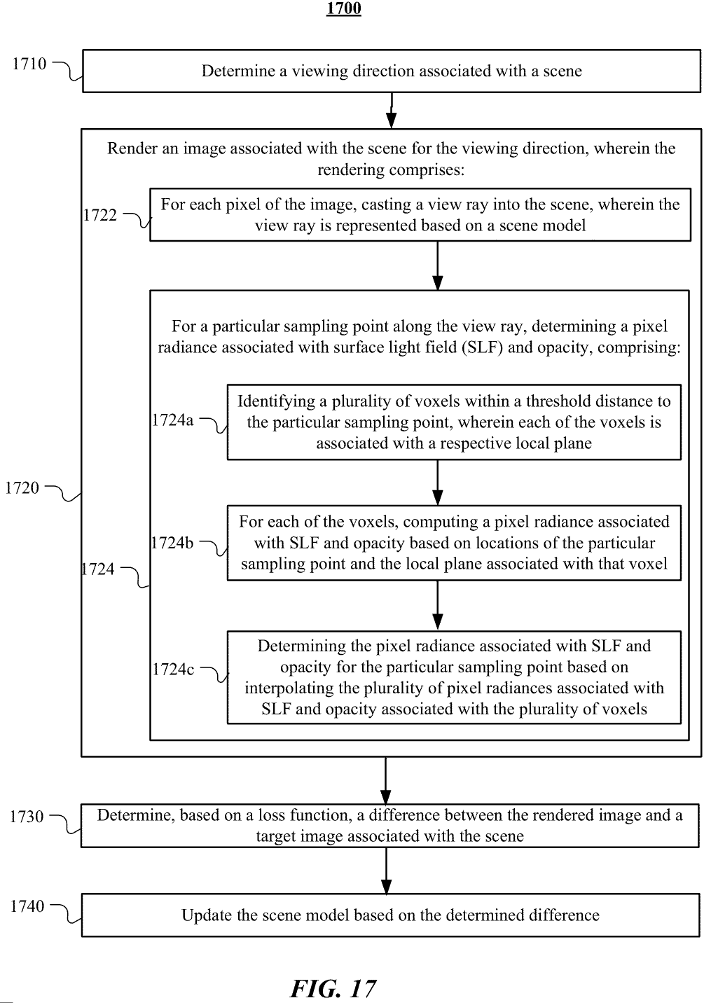

FIG. 17 illustrates an example method 1700 for explicit 3D reconstruction. The method may begin at step 1710, where a computing system may determine a viewing direction associated with a scene. At step 1720, the computing system may render an image associated with the scene for the viewing direction, wherein the rendering may comprise the following sub-steps. At sub-step 1722, the computing system may, for each pixel of the image, cast a view ray into the scene, wherein the view ray is represented based on a scene model. At sub-step 1724, the computing system may, for a particular sampling point along the view ray, determine a pixel radiance associated with surface light field (SLF) and opacity, comprising the following sub-steps. At sub-step 1724a, the computing system may identify a plurality of voxels within a threshold distance to the particular sampling point, wherein each of the voxels is associated with a respective local plane. At sub-step 1724a, the computing system may, for each of the voxels, computing a pixel radiance associated with SLF and opacity based on locations of the particular sampling point and the local plane associated with that voxel. At sub-step 1724a, the computing system may determine the pixel radiance associated with SLF and opacity for the particular sampling point based on interpolating the plurality of pixel radiances associated with SLF and opacity associated with the plurality of voxels. In particular embodiments, the computing system may further determine, based on a loss function, a difference between the rendered image and a target image associated with the scene at step 1730. In particular embodiments, the computing system may further update the scene model based on the determined difference at step 1740. Particular embodiments may repeat one or more steps of the method of FIG. 17, where appropriate. Although this disclosure describes and illustrates particular steps of the method of FIG. 17 as occurring in a particular order, this disclosure contemplates any suitable steps of the method of FIG. 17 occurring in any suitable order. Moreover, although this disclosure describes and illustrates an example method for explicit 3D reconstruction including the particular steps of the method of FIG. 17, this disclosure contemplates any suitable method for explicit 3D reconstruction including any suitable steps, which may include all, some, or none of the steps of the method of FIG. 17, where appropriate. Furthermore, although this disclosure describes and illustrates particular components, devices, or systems carrying out particular steps of the method of FIG. 17, this disclosure contemplates any suitable combination of any suitable components, devices, or systems carrying out any suitable steps of the method of FIG. 17.

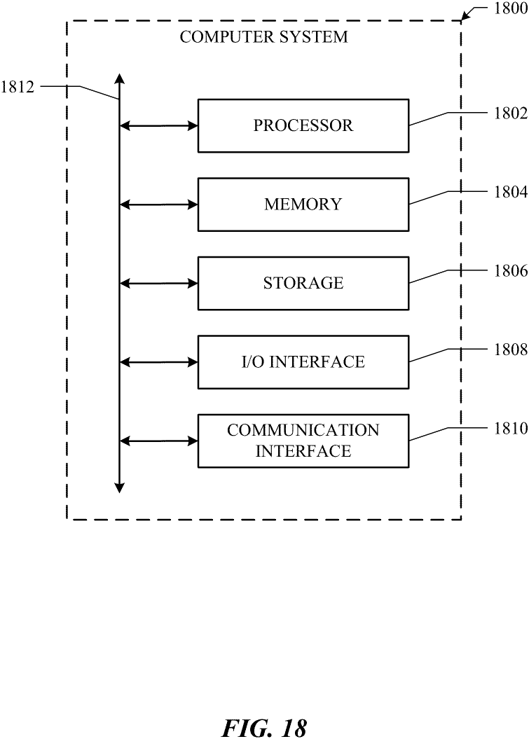

FIG. 18 illustrates an example computer system 1800. In particular embodiments, one or more computer systems 1800 perform one or more steps of one or more methods described or illustrated herein. In particular embodiments, one or more computer systems 1800 provide functionality described or illustrated herein. In particular embodiments, software running on one or more computer systems 1800 performs one or more steps of one or more methods described or illustrated herein or provides functionality described or illustrated herein. Particular embodiments include one or more portions of one or more computer systems 1800. Herein, reference to a computer system may encompass a computing device, and vice versa, where appropriate. Moreover, reference to a computer system may encompass one or more computer systems, where appropriate.

This disclosure contemplates any suitable number of computer systems 1800. This disclosure contemplates computer system 1800 taking any suitable physical form. As example and not by way of limitation, computer system 1800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1800 may include one or more computer systems 1800; be unitary or distributed; span multiple locations; span multiple machines; span multiple data centers; or reside in a cloud, which may include one or more cloud components in one or more networks. Where appropriate, one or more computer systems 1800 may perform without substantial spatial or temporal limitation one or more steps of one or more methods described or illustrated herein. As an example and not by way of limitation, one or more computer systems 1800 may perform in real time or in batch mode one or more steps of one or more methods described or illustrated herein. One or more computer systems 1800 may perform at different times or at different locations one or more steps of one or more methods described or illustrated herein, where appropriate.

In particular embodiments, computer system 1800 includes a processor 1802, memory 1804, storage 1806, an input/output (I/O) interface 1808, a communication interface 1810, and a bus 1812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1802 includes hardware for executing instructions, such as those making up a computer program. As an example and not by way of limitation, to execute instructions, processor 1802 may retrieve (or fetch) the instructions from an internal register, an internal cache, memory 1804, or storage 1806; decode and execute them; and then write one or more results to an internal register, an internal cache, memory 1804, or storage 1806. In particular embodiments, processor 1802 may include one or more internal caches for data, instructions, or addresses. This disclosure contemplates processor 1802 including any suitable number of any suitable internal caches, where appropriate. As an example and not by way of limitation, processor 1802 may include one or more instruction caches, one or more data caches, and one or more translation lookaside buffers (TLBs). Instructions in the instruction caches may be copies of instructions in memory 1804 or storage 1806, and the instruction caches may speed up retrieval of those instructions by processor 1802. Data in the data caches may be copies of data in memory 1804 or storage 1806 for instructions executing at processor 1802 to operate on; the results of previous instructions executed at processor 1802 for access by subsequent instructions executing at processor 1802 or for writing to memory 1804 or storage 1806; or other suitable data. The data caches may speed up read or write operations by processor 1802. The TLBs may speed up virtual-address translation for processor 1802. In particular embodiments, processor 1802 may include one or more internal registers for data, instructions, or addresses. This disclosure contemplates processor 1802 including any suitable number of any suitable internal registers, where appropriate. Where appropriate, processor 1802 may include one or more arithmetic logic units (ALUs); be a multi-core processor; or include one or more processors 1802. Although this disclosure describes and illustrates a particular processor, this disclosure contemplates any suitable processor.

In particular embodiments, memory 1804 includes main memory for storing instructions for processor 1802 to execute or data for processor 1802 to operate on. As an example and not by way of limitation, computer system 1800 may load instructions from storage 1806 or another source (such as, for example, another computer system 1800) to memory 1804. Processor 1802 may then load the instructions from memory 1804 to an internal register or internal cache. To execute the instructions, processor 1802 may retrieve the instructions from the internal register or internal cache and decode them. During or after execution of the instructions, processor 1802 may write one or more results (which may be intermediate or final results) to the internal register or internal cache. Processor 1802 may then write one or more of those results to memory 1804. In particular embodiments, processor 1802 executes only instructions in one or more internal registers or internal caches or in memory 1804 (as opposed to storage 1806 or elsewhere) and operates only on data in one or more internal registers or internal caches or in memory 1804 (as opposed to storage 1806 or elsewhere). One or more memory buses (which may each include an address bus and a data bus) may couple processor 1802 to memory 1804. Bus 1812 may include one or more memory buses, as described below. In particular embodiments, one or more memory management units (MMUs) reside between processor 1802 and memory 1804 and facilitate accesses to memory 1804 requested by processor 1802. In particular embodiments, memory 1804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1804 may include one or more memories 1804, where appropriate. Although this disclosure describes and illustrates particular memory, this disclosure contemplates any suitable memory.

In particular embodiments, storage 1806 includes mass storage for data or instructions. As an example and not by way of limitation, storage 1806 may include a hard disk drive (HDD), a floppy disk drive, flash memory, an optical disc, a magneto-optical disc, magnetic tape, or a Universal Serial Bus (USB) drive or a combination of two or more of these. Storage 1806 may include removable or non-removable (or fixed) media, where appropriate. Storage 1806 may be internal or external to computer system 1800, where appropriate. In particular embodiments, storage 1806 is non-volatile, solid-state memory. In particular embodiments, storage 1806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1806 taking any suitable physical form. Storage 1806 may include one or more storage control units facilitating communication between processor 1802 and storage 1806, where appropriate. Where appropriate, storage 1806 may include one or more storages 1806. Although this disclosure describes and illustrates particular storage, this disclosure contemplates any suitable storage.

In particular embodiments, I/O interface 1808 includes hardware, software, or both, providing one or more interfaces for communication between computer system 1800 and one or more I/O devices. Computer system 1800 may include one or more of these I/O devices, where appropriate. One or more of these I/O devices may enable communication between a person and computer system 1800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1808 for them. Where appropriate, I/O interface 1808 may include one or more device or software drivers enabling processor 1802 to drive one or more of these I/O devices. I/O interface 1808 may include one or more I/O interfaces 1808, where appropriate. Although this disclosure describes and illustrates a particular I/O interface, this disclosure contemplates any suitable I/O interface.

In particular embodiments, communication interface 1810 includes hardware, software, or both providing one or more interfaces for communication (such as, for example, packet-based communication) between computer system 1800 and one or more other computer systems 1800 or one or more networks. As an example and not by way of limitation, communication interface 1810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1810 for it. As an example and not by way of limitation, computer system 1800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1800 may include any suitable communication interface 1810 for any of these networks, where appropriate. Communication interface 1810 may include one or more communication interfaces 1810, where appropriate. Although this disclosure describes and illustrates a particular communication interface, this disclosure contemplates any suitable communication interface.

In particular embodiments, bus 1812 includes hardware, software, or both coupling components of computer system 1800 to each other. As an example and not by way of limitation, bus 1812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1812 may include one or more buses 1812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both j oint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by one or more computing systems:
determining a viewing direction associated with a scene; and
rendering an image associated with the scene for the viewing direction, wherein the rendering comprises:
for each pixel of the image, casting a view ray into the scene; and
for a particular sampling point along the view ray, determining a pixel radiance associated with surface light field (SLF) and opacity, comprising:
identifying a plurality of voxels within a threshold distance to the particular sampling point, wherein each of the voxels is associated with a respective local plane;
for each of the voxels, computing a pixel radiance associated with SLF and opacity based on locations of the particular sampling point and the local plane associated with that voxel; and
determining the pixel radiance associated with SLF and opacity for the particular sampling point based on interpolating the plurality of pixel radiances associated with SLF and opacity associated with the plurality of voxels.

2. The method of claim 1, further comprising:
accessing a set of multi-view images associated with the scene, wherein the multi-view images depict the scene from a plurality of distinct viewing directions.

3. The method of claim 2, further comprising:
determining a plurality of sensor poses and a plurality of calibrations associated with the set of multi-view images.

4. The method of claim 3, further comprising:
determining, for each of the set of multi-view images, a plurality of corners associated with a scene axis-aligned bounding box associated with the scene.

5. The method of claim 4, further comprising:
generating a scene model based on the set of multi-view images, the plurality of sensor poses, the plurality of calibrations, and the plurality of corners for each of the set of multi-view images, wherein the view ray is represented based on the scene model.

6. The method of claim 5, wherein the scene model comprises a sparse voxel octree (SVO).

7. The method of claim 6, wherein the SVO stores one or more of:
a first volumetric scalar field with opacity defining surface geometry; or
a second volumetric vector field with spherical harmonics defining a scene SLF.

8. The method of claim 6, wherein the SVO comprises a plurality of tree levels, wherein each of the plurality of tree levels represents the scene at a specific level of detail.

9. The method of claim 8, further comprising:
determining, based on an area of the view ray, one or more levels of detail to use for rendering the image.

10. The method of claim 6, wherein the SVO comprises a plurality of tree nodes, wherein the plurality of tree nodes store the plurality of local planes.

11. The method of claim 10, wherein each of the plurality of local planes is based on a four-dimensional coordinate comprising a tree-node center and a depth.

12. The method of claim 6, wherein the scene model further comprises one or more of a background cube map comprising a plurality of texels or an environment map representing a plurality of distant scene regions associated with the scene.

13. The method of claim 5, further comprising:
editing the scene based on one or more user edits on the scene model.

14. The method of claim 1, wherein interpolating each of the plurality of pixel radiances associated with SLF and opacity associated with each of the plurality of voxels is based on a four-dimensional interpolation based on spatial information and level of detail.

15. The method of claim 1, wherein interpolating the plurality of pixel radiances associated with SLF and opacity associated with the plurality of voxels comprises:
determining one or more weights for each of the plurality of pixel radiances based on a distance between the particular sampling point and the local plane associated with that voxel, wherein interpolating the plurality of pixel radiances associated with SLF and opacity associated with the plurality of voxels is based on the determined weights for each of the plurality of pixel radiances.

16. The method of claim 1, wherein each of the plurality of voxels stores one or more functions associated with the respective local plane.

17. The method of claim 1, further comprising:
mapping the pixel radiance associated with SLF and opacity to one or more pixel intensities.

18. The method of claim 1, further comprising:
determining a plurality of additional sampling points along the view ray; and
determining an aggregated pixel radiance for the pixel based on aggregating a plurality of pixel radiances associated with SLF and opacity associated with the plurality of additional sampling points;
wherein rendering the image is based on the aggregated pixel radiance for the pixel.

19. One or more computer-readable non-transitory storage media embodying software that is operable when executed to:
determine a viewing direction associated with a scene; and
render an image associated with the scene for the viewing direction, wherein the rendering comprises:
for each pixel of the image, casting a view ray into the scene; and
for a particular sampling point along the view ray, determining a pixel radiance associated with surface light field (SLF) and opacity, comprising:
identifying a plurality of voxels within a threshold distance to the particular sampling point, wherein each of the voxels is associated with a respective local plane;
for each of the voxels, computing a pixel radiance associated with SLF and opacity based on locations of the particular sampling point and the local plane associated with that voxel; and
determining the pixel radiance associated with SLF and opacity for the particular sampling point based on interpolating the plurality of pixel radiances associated with SLF and opacity associated with the plurality of voxels.

20. A system comprising: one or more processors; and a non-transitory memory coupled to the processors comprising instructions executable by the processors, the processors operable when executing the instructions to:
determine a viewing direction associated with a scene; and
render an image associated with the scene for the viewing direction, wherein the rendering comprises:
for each pixel of the image, casting a view ray into the scene; and
for a particular sampling point along the view ray, determining a pixel radiance associated with surface light field (SLF) and opacity, comprising:
identifying a plurality of voxels within a threshold distance to the particular sampling point, wherein each of the voxels is associated with a respective local plane;
for each of the voxels, computing a pixel radiance associated with SLF and opacity based on locations of the particular sampling point and the local plane associated with that voxel; and
determining the pixel radiance associated with SLF and opacity for the particular sampling point based on interpolating the plurality of pixel radiances associated with SLF and opacity associated with the plurality of voxels.
